(19) United States
(12) Patent Application Publication
(10) Pub. No.: US 2022/0221986 A1
(43) Pub. Date: Jul. 14, 2022

(54) FABRIC MEMORY NETWORK-ON-CHIP

(71) Applicants: Scott Jeremy Weber, Piedmont, CA (US); Ashish Gupta, San Jose, CA (US); Navid Azizi, Toronto (CA); Ilya K. Ganusov, San Jose, CA (US); Kalen Brunham, Toronto (CA); Przemek Guzy, Oakville (CA); Rajiv Kumar, Pulau (MY); Thuyet Ngo, Bayan Lepas (MY); Mark Honman, Holmer Green (GB)

(72) Inventors: Scott Jeremy Weber, Piedmont, CA (US); Ashish Gupta, San Jose, CA (US); Navid Azizi, Toronto (CA); Ilya K. Ganusov, San Jose, CA (US); Kalen Brunham, Toronto (CA); Przemek Guzy, Oakville (CA); Rajiv Kumar, Pulau (MY); Thuyet Ngo, Bayan Lepas (MY); Mark Honman, Holmer Green (GB)

(21) Appl. No.: 17/711,840

(22) Filed: Apr. 1, 2022

Related U.S. Application Data
(60) Provisional application No. 63/311,028, filed on Feb. 16, 2022.

(51) Int. Cl. G06F 3/06

(52) U.S. Cl. CPC G06F 3/064; G06F 3/0604; G06F 3/0673

(57) ABSTRACT

An integrated circuit device includes a programmable fabric that has a plurality of memory blocks. The integrated circuit device also includes a network-on-chip (NOC) located on a shoreline of the programmable fabric and at least one micro NOC formed with hardened resources in the programmable fabric. The at least one micro NOC is communicatively coupled to the NOC and to at least one memory block of the plurality of memory blocks. Additionally, the at least one micro NOC is configurable to route data between the NOC and the at least one memory block.

### CROSS-REFERENCE TO RELATED APPLICATIONS

This application claims priority to U.S. Provisional Application No. 63/311,028 filed Feb. 16, 2022, entitled “Fabric Memory Network-On-Chip,” which is incorporated herein by reference in its entirety for all purposes.

### BACKGROUND

The present disclosure relates generally to integrated circuits, such as field-programmable gate arrays (FPGAs). More particularly, the present disclosure relates to micro networks-on-chip (NOCs) that may be implemented on integrated circuits, including FPGAs.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits can be utilized to perform various functions, such as encryption and machine learning. Moreover, various portions of integrated circuits may be utilized to perform various operations. For example, one portion of an integrated circuit may perform one function to data, and another portion of the integrated circuit may be utilized to further process the data. As data is to be processed, the data may be read from memory, and processed data may be written to the memory. NOCs may be utilized to route communication between different portions of an integrated circuit or for communication between multiple integrated circuits. However, the communications between a NOC and memory (e.g., memory blocks) may utilize fabric resources (e.g., wires) or soft logic of the integrated circuit (e.g., for communicating data between a memory block and the NOC). Utilizing fabric resources or soft logic resources may result in a reduced efficiency of the integrated circuit because the fabric resources and the soft logic used to enable communication between the NOC and memory blocks may not be usable for performing other various functions of the integrated circuit, such as processing data.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various aspects of this disclosure may be better understood upon reading the following detailed description and upon reference to the drawings in which:

FIG. 1 is a block diagram of a system for implementing circuit designs on an integrated circuit device, in accordance with an embodiment;

FIG. 2 is a block diagram of the integrated circuit device of FIG. 1, in accordance with an embodiment of the present disclosure;

FIG. 3 is a block diagram of the integrated circuit device of FIG. 1, in accordance with an embodiment of the present disclosure;

FIG. 4 is a block diagram of the integrated circuit device of FIG. 1, in accordance with an embodiment of the present disclosure;

FIG. 5 is a block diagram of the interface of FIG. 4, in accordance with an embodiment of the present disclosure;

FIG. 6 is a block diagram illustrating a read operation using the response buffer of FIG. 5, in accordance with an embodiment of the present disclosure;

FIG. 7 is a block diagram illustrating a write operation using the response buffer of FIG. 5, in accordance with an embodiment of the present disclosure;

FIG. 8 is a block diagram illustrating design entries of the micro NOC of FIG. 3, in accordance with an embodiment of the present disclosure;

FIG. 9 is a block diagram illustrating a mapping of the micro NOC of FIG. 3, in accordance with an embodiment of the present disclosure;

FIG. 10 is a block diagram illustrating a read operation with the micro NOC of FIG. 3, in accordance with an embodiment of the present disclosure;

FIG. 11 is a block diagram of packing operations of RDATA, in accordance with an embodiment of the present disclosure;

FIG. 12 is a block diagram illustrating a read operation with one of the micro NOCs of FIG. 3, in accordance with an embodiment of the present disclosure;

FIG. 13 is a block diagram illustrating a streaming operation with one of the micro NOCs of FIG. 3, in accordance with an embodiment of the present disclosure;

FIG. 14 is a block diagram illustrating a ping pong operation with one of the micro NOCs of FIG. 3, in accordance with an embodiment of the present disclosure;

FIG. 15 is a block diagram illustrating a memory paging operation with one of the micro NOCs of FIG. 3, in accordance with an embodiment of the present disclosure;

FIG. 16 is a block diagram illustrating a multicast writing operation with one of the micro NOCs of FIG. 3, in accordance with an embodiment of the present disclosure;

FIG. 17 is a block diagram of transaction descriptors for several micro NOCs, in accordance with an embodiment of the present disclosure;

FIG. 18 is a block diagram of a bus structure of the micro NOCs of FIG. 3, in accordance with an embodiment of the present disclosure;

FIG. 19A is a block diagram illustrating a mapping of groups of memory blocks disposed along micro NOCs, in accordance with an embodiment of the present disclosure;

FIG. 19B is a block diagram showing response buffer entries associated with the micro NOCs of FIG. 19A, in accordance with an embodiment of the present disclosure;

FIG. 20 is a block diagram illustrating a read operation using micro NOC streaming semantics with a micro NOC, in accordance with an embodiment of the present disclosure;

FIG. 21 is a block diagram illustrating a write operation using micro NOC streaming semantics with a micro NOC, in accordance with an embodiment of the present disclosure;

FIG. 22 is a block diagram of a read operation in a reset mode of operation, in accordance with an embodiment of the present disclosure;

FIG. 23 is a block diagram of a read operation in a FIFO mode of operation, in accordance with an embodiment of the present disclosure;

FIG. 24 is a block diagram of a write operation in a FIFO mode of operation, in accordance with an embodiment of the present disclosure;

FIG. 25 is a block diagram of a write operation in a reset mode of operation, in accordance with an embodiment of the present disclosure;

FIG. 26 is a block diagram of a read operation using micro NOC multicast semantics, in accordance with an embodiment of the present disclosure;

FIG. 27 is a block diagram of a disaggregated mapping of groups of memory blocks within micro NOCs, in accordance with an embodiment of the present disclosure;

FIG. 28 is a block diagram of differently sized groups of memory blocks mapped to micro NOCs, in accordance with an embodiment of the present disclosure;

FIG. 29 is a block diagram illustrating read operations with a group of memory blocks, in accordance with an embodiment of the present disclosure;

FIG. 30 is a block diagram illustrating write operations with a group of memory blocks, in accordance with an embodiment of the present disclosure;

FIG. 31 is a block diagram of a disaggregated mapping of groups of differently sized memory blocks within micro NOCs, in accordance with an embodiment of the present disclosure;

FIG. 32 is a block diagram illustrating ping ponging operations in micro NOCs, in accordance with an embodiment of the present disclosure;

FIG. 33 is a block diagram illustrating the ping ponging operations of FIG. 32 in a read operation, in accordance with an embodiment of the present disclosure;

FIG. 34 is a block diagram illustrating the ping ponging operations of FIG. 32 in a write operation, in accordance with an embodiment of the present disclosure; and

FIG. 35 is a block diagram of a data processing system that includes the integrated circuit of FIG. 1, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, “hard logic” generally refers to portions of an integrated circuit device (e.g., a programmable logic device) that are not programmable by an end user, and the portions of the integrated circuit device that are programmable by the end user are considered “soft logic.” For example, hard logic elements in a programmable logic device such as an FPGA may include arithmetic units (e.g., digital signal processing (DSP) blocks) that are included in the FPGA and unchangeable by the end user, whereas soft logic includes programmable logic elements included in the FPGA.

The present systems and techniques relate to embodiments for an integrated circuit including a network-on-chip (NOC) connected to one or more micro NOCs that are implemented as fixed (e.g., hardened) connections in the integrated circuit. The integrated circuit may include a response buffer that is configurable to intercept data transmissions that would go from the NOC to memory devices (e.g., memory blocks) of the integrated circuit via soft logic or wires. After intercepting the data, the response buffer may transmit the data to the memory blocks using a micro NOC, which may be hardened and may extend deep into a programmable fabric of the integrated circuit. In this manner, data may transported (e.g., in response to read or write requests) between NOCs and memory blocks more quickly and efficiently, thereby reducing latency and increasing throughput.

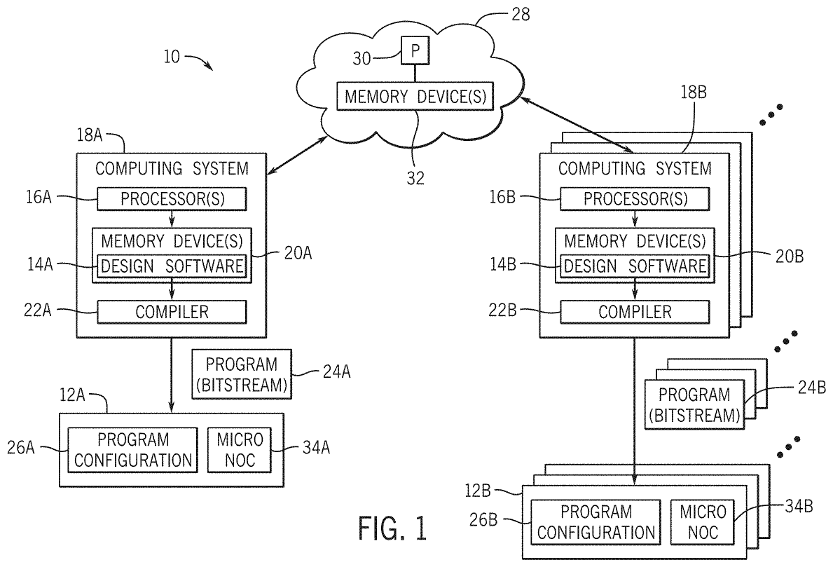

With the foregoing in mind, FIG. 1 illustrates a block diagram of a system 10 that may be used to program one or more integrated circuit device 12 (e.g., integrated circuit devices 12A, 12B). The integrated circuit device 12 may be reconfigurable (e.g., FPGA) or may be an application-specific integrated circuit (ASIC). A user may implement a circuit design to be programmed onto the integrated circuit device 12 using design software 14, such as a version of Intel® Quartus® by INTEL CORPORATION.

The design software 14 may be executed by one or more processors 16 of a respective computing system 18. The computing system 18 may include any suitable device capable of executing the design software 14, such as a desktop computer, a laptop, a mobile electronic device, a server, or the like. The computing system 18 may access, configure, and/or communicate with the integrated circuit device 12. The processor(s) 16 may include multiple microprocessors, one or more other integrated circuits (e.g., ASICs, FPGAs, reduced instruction set processors, and the like), or some combination of these.

One or more memory devices 20 may store the design software 14. In addition, the memory device(s) 20 may store information related to the integrated circuit device 12, such as control software, configuration software, look up tables, configuration data, etc. In some embodiments, the processor(s) 16 and/or the memory device(s) 20 may be external to the computing system 18. The memory device(s) 20 may include a tangible, non-transitory, machine-readable-medium, such as a volatile memory (e.g., a random access memory (RAM)) and/or a nonvolatile memory (e.g., a read-only memory (ROM)). The memory device(s) 20 may store a variety of information that may be used for various purposes. For example, the memory device(s) 20 may store machine-readable and/or processor-executable instructions (e.g., firmware or software) for the processor(s) 16 to execute, such as instructions to determine a speed of the integrated circuit device 12 or a region of the integrated circuit device 12, determine a criticality of a path of a design programmed in the integrated circuit device 12 or a region of the integrated circuit device 12, programming the design in the integrated circuit device 12 or a region of the integrated circuit device 12, and the like. The memory device(s) 20 may include one or more storage devices (e.g., nonvolatile storage devices) that may include read-only memory (ROM), flash memory, a hard drive, or any other suitable optical, magnetic, or solid-state storage medium, or any combination thereof.

The design software 14 may use a compiler 22 to generate a low-level circuit-design program 24 (bitstream), sometimes known as a program object file, which programs the integrated circuit device 12. That is, the compiler 22 may provide machine-readable instructions representative of the circuit design to the integrated circuit device 12. For example, the integrated circuit device 12 may receive one or more programs 24 as bitstreams that describe the hardware implementations that should be stored in the integrated circuit device 12. The programs 24 (bitstreams) may programmed into the integrated circuit device 12 as a program configuration 26 (e.g., program configuration 26A, program configuration 26B).

As illustrated, the system 10 also includes a cloud computing system 28 that may be communicatively coupled to the computing systems 18, for example, via the internet or a network connection. The cloud computing system 28 may include processing circuitry 30 and one or more memory devices 32. The memory device(s) 32 may store information related to the integrated circuit device 12, such as control software, configuration software, look up tables, configuration data, etc. The memory device(s) 32 may include a tangible, non-transitory, machine-readable-medium, such as a volatile memory (e.g., a random access memory (RAM)) and/or a nonvolatile memory (e.g., a read-only memory (ROM)). The memory device(s) 32 may store a variety of information that may be used for various purposes. For example, the memory device(s) 32 may store machine-readable and/or processor-executable instructions (e.g., firmware or software) for the processing circuitry 30 to execute. Additionally, the memory device(s) 32 of the cloud computing system 28 may include programs 24 and circuit designs previously made by designers and the computing systems 18.

The integrated circuit devices 12 may include micro networks-on-chip (micro NOCs) 34 (collectively referring to micro NOC(s) 34A and micro NOC(s) 34B). For example, one or more micro NOCs may be dispersed in the integrated circuit device 12 to enable communication throughout the integrated circuit device 12. For example, as discussed below, the micro NOCs 34 may be implemented using hardened fabric resources on the integrated circuit device 12 between another NOC and one or more memory blocks included on the integrated circuit device 12. Additionally, the micro NOCs 34 (or any other micro NOC) may be implemented as described in U.S. patent application Ser. No. 17/132,663, entitled “MICRO-NETWORK-ON-CHIP AND MICROSECTOR INFRASTRUCTURE,” which is incorporated by reference in its entirety for all purposes. It should be noted that while U.S. patent application Ser. No. 17/132,663 describes an embodiment of a micro NOC, other embodiments of micro NOCs may be used.

The memory device(s) 32 may also include one or more libraries of chip-specific predefined locations and fixed routes that may be utilized to generate a NOC or program a micro NOC. When a designer is utilizing the design software 14, the processor(s) 16 may request information regarding NOCs or micro NOCs previously designed by other designers or implemented on other integrated circuit device 12. For instance, a designer who is working on programming the integrated circuit device 12A may utilize the design software 14A and processor(s) 16A to request a design for a NOC or characteristics of a micro NOC used on another integrated circuit (e.g., integrated circuit device 12B) from the cloud computing system 28. The processing circuitry 30 may generate and/or retrieve a design of a NOC or characteristics of micro NOC from the memory devices(s) 32 and provide the design to the computing system 18A. Additionally, the cloud computing system 28 may provide information regarding the predefined locations and fixed routes for a NOC or micro NOC to the computing system 18A based on the specific integrated circuit device 12A (e.g., a particular chip). Furthermore, the memory device(s) 32 may keep records and/or store designs that are used to provide NOCs and micro NOCs with regularized structures, and the processing circuitry 30 may select specific NOCs or micro NOCs based on the integrated circuit device 12A as well as design considerations of the designer (e.g., amounts of data to be transferred, desired speed of data transmission).

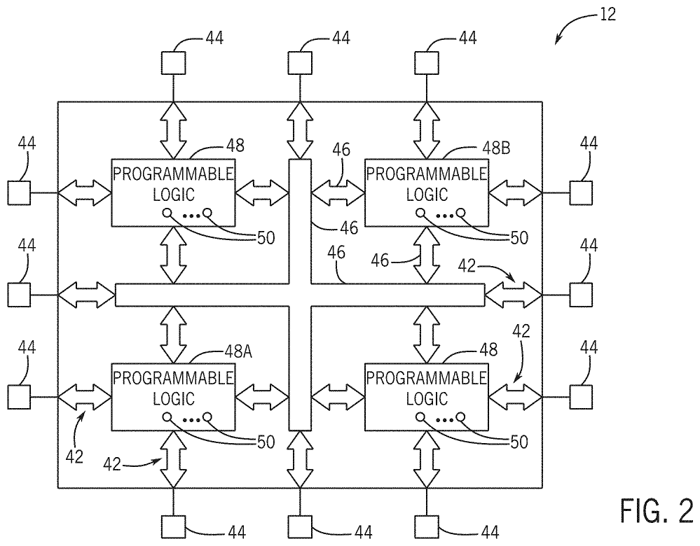

Turning now to a more detailed discussion of the integrated circuit device 12, FIG. 2 illustrates an example of the integrated circuit device 12 as a programmable logic device, such as a field-programmable gate array (FPGA). Further, it should be understood that the integrated circuit device 12 may be any other suitable type of programmable logic device (e.g., an application-specific integrated circuit and/or application-specific standard product). As shown, integrated circuit device 12 may have input/output circuitry 42 for driving signals off device and for receiving signals from other devices via input/output pins 44. Interconnection resources 46, such as global and local vertical and horizontal conductive lines and buses, may be used to route signals on integrated circuit device 12. Additionally, interconnection resources 46 may include fixed interconnects (conductive lines) and programmable interconnects (i.e., programmable connections between respective fixed interconnects). Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as integrated circuit device 12, may contain programmable elements 50 with the programmable logic 48. For example, as discussed above, a designer (e.g., a customer) may program (e.g., configure) the programmable logic 48 to perform one or more desired functions. By way of example, some programmable logic devices may be programmed by configuring their programmable elements 50 using mask programming arrangements, which is performed during semiconductor manufacturing. Other programmable logic devices are configured after semiconductor fabrication operations have been completed, such as by using electrical programming or laser programming to program their programmable elements 50. In general, programmable elements 50 may be based on any suitable programmable technology, such as fuses, antifuses, electrically-programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using pins 44 and input/output circuitry 42. In one embodiment, the memory cells may be implemented as random-access-memory (RAM) cells. The use of memory cells based on RAM technology is described herein is intended to be only one example. Further, because these RAM cells are loaded with configuration data during programming, they are sometimes referred to as configuration RAM cells (CRAM). These memory cells may each provide a corresponding static control output signal that controls the state of an associated logic component in programmable logic 48. For instance, in some embodiments, the output signals may be applied to the gates of metal-oxide-semiconductor (MOS) transistors within the programmable logic 48.

Furthermore, it should be noted that the programmable logic 48 may correspond to different portions or sectors on the integrated circuit device 12. That is, the integrated circuit device 12 may be sectorized, meaning that programmable logic resources may be distributed through a number of discrete programmable logic sectors (e.g., each programmable logic 48). In some cases, sectors may be programmed to perform specific tasks. For example, a first sector (e.g., programmable logic 48A) may perform a first operation on data. The interconnect resources 46, which may include a NOC designed using the design software 14, may be utilized to provide the data to another sector (e.g., programmable logic 48B), which may perform further operations on the data.

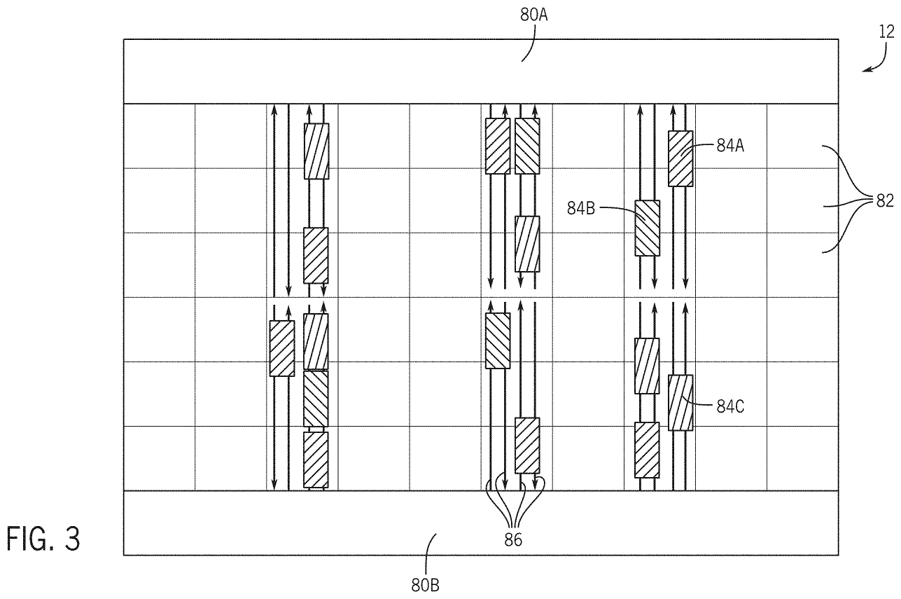

Turning now to a more detailed discussion of the integrated circuit 12, FIG. 3 shows the integrated circuit 12, including a north NOC 80A and a south NOC 80B, both of which may be hardened and provide shoreline connections throughout the integrated circuit 12. In other words, in one embodiment, the NOCs 80 (referring collectively to north NOC 80A and south NOC 80B) may be hard NOCs. In other embodiments, the NOCs 80 may be soft NOCs that are generated by the design software 14. The integrated circuit 12 may also include a fabric that may include programmable fabric 82, which may include programmable logic elements (e.g., programmable logic 48) and interconnection resources 46. The programmable fabric 82 of the fabric of the integrated circuit 12 may also have memory blocks 84 that are dispersed throughout the fabric. For example, there may be groups of memory blocks 84 such as memory blocks 84A, 84B, and 84C in the programmable fabric 82. In some embodiments, the memory blocks 84A, 84B, and 84C, as well as other memory blocks 84, may be M20Ks, M144Ks, or any other type of memory block or embedded memory device (e.g., memory logic array block (MLAB).

To enable enhanced communication to and from the memory blocks 84A, 84B, and 84C, the north NOC 80A and the south NOC 80B may be communicatively coupled to micro NOCs 86. The micro NOCs 86 are dedicated, hardened fabric resources used to communicate data between the NOCS 80A and 80B and the memory blocks 84 (for example, 84A, 84B, and 84C) in the fabric of the integrated circuit 12. In other words, the micro NOCs 86 may be included in the integrated circuit device 12 and not physically formed based on a program design implemented on the integrated circuit 12. The integrated circuit 12 may include any suitable number of micro NOCs 86. For example, there may be one, five, ten, fifteen, twenty, twenty-five, dozens, hundreds, or any other desired number of micro NOCs 86 in the integrated circuit 12. The micro NOCs 86 may be oriented in a north-to-south orientation, to enable communication from the north NOC 80A and the south NOC 80B to the memory blocks 84A, 84B, and 84C dispersed throughout the fabric along the micro NOCs 86. However, in some embodiments there may be east and west NOCs with horizontally-oriented micro NOCs 86 to enable communication between the east and west NOCs and the memory blocks 84A, 84B, and 84C dispersed throughout the fabric of the integrated circuit device 12.

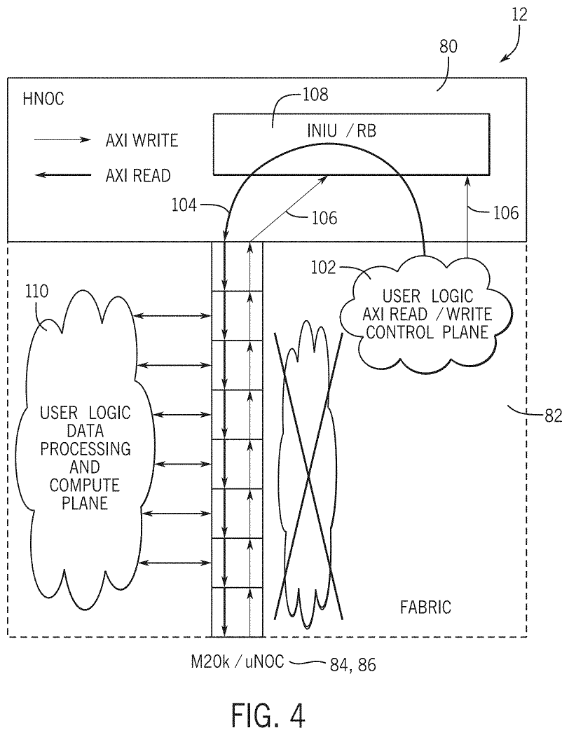

Turning now to a more detailed discussion of the communications enabled by the micro NOCs 86, FIG. 4 is another block diagram of the integrated circuit device 12. User logic 102 (which may be implemented based on a bitstream or design generated using the design software 14) may request data be read from or written to the memory blocks 84A, 84B, and 84C. In some embodiments the user logic 102 may be implemented in the form of an advanced extensible interface (AXI) protocol. However, in some embodiments other protocols or interfaces may be used, such as the Avalon® memory-mapped (AVMM) interfaces using an AVMM protocol. The user logic 102 cause the transmission of a read signal 104 or a write signal 106 to an AXI interface 108, which may be located in a NOC 80 (e.g., north NOC 80A or south NOC 80B) of the integrated circuit 12. The AXI interface 108 may also be an interface for any other protocol, such as the AVMM protocol.

The AXI interface 108 may receive a read signal 104 from the user logic 102, and selectively transmit the signal 104 from the NOC 80 to a micro NOC 86. The micro NOC 86 may then deposit the read data from the read signal 104 into the memory block 84A, 84B, 84C, or any other memory block.

Additionally or alternatively, the AXI interface 108 may receive a write signal 106 from the user logic 102 and selectively transmit the signal 106 from the NOC 80 to a micro NOC 86. The micro NOC 86 may then deposit the read data requested in the write signal 106 from the memory block 84A, 84B, 84C, or any other memory block, and may transmit the data to the AXI interface 108.

In some embodiments, the selection of memory blocks 84A, 84B, or 84C from which to read or write can be decided at runtime. Accordingly, the micro NOC 86 may replace fabric wires and soft logic in the fabric 82 while enabling dynamically reading and writing different memory blocks 84A, 84B, or 84C and to transport the data to and from the NOCs 80A and 80B. Further, because the micro NOCs 86 are hardened, the micro NOCs 86 do not compete for resources (e.g., soft logic, wires of the fabric 82) that may otherwise be utilized in the design, and the micro NOCs are also timing closed.

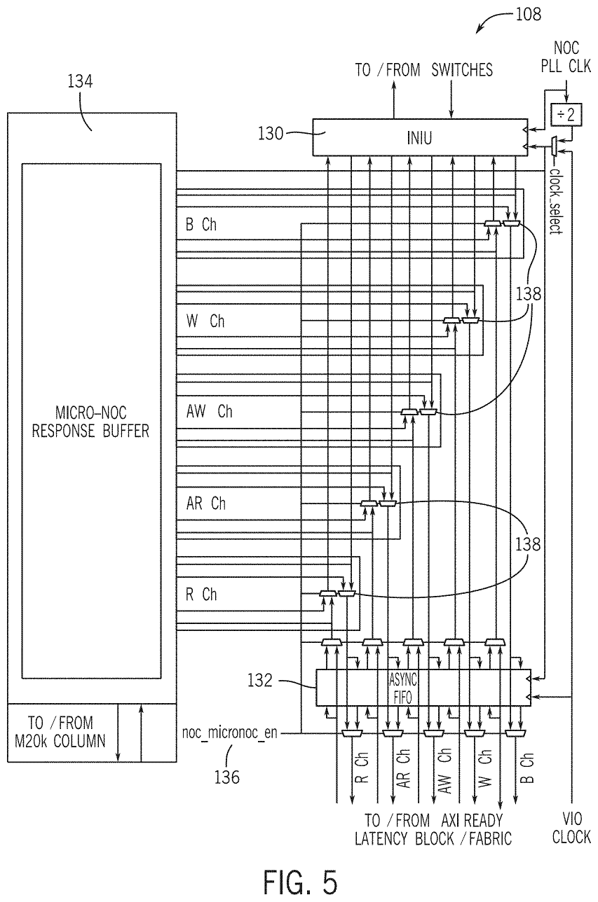

FIG. 5 illustrates a more detailed view of the AXI interface 108 relative to FIG. 4. As illustrated, the AXI interface 108 may include an initiator network interface unit (INIU) 130, a fabric AXI initiator interface 132, and a response buffer 134. In some embodiments, the INIU 130 may transmit data to the programmable fabric 82 via the fabric AXI initiator interface 132, which, when no micro NOCs 86 are present, may use soft logic resources within the programmable fabric 82 be relay the data. The response buffer 134, in some embodiments, redirects the data to a micro NOC 86 instead of the fabric AXI initiator interface 132. In other words, the response buffer 134 may intercept data that is transmitted from the INIU 130 to the fabric AXI initiator interface 132 or from the fabric AXI initiator to the INIU 130. Accordingly, in some embodiments, transactions targeted to/from the micro NOCs 86 and transactions targeted to/from the programmable fabric 82 may be freely interleaved.

In some embodiments, a micro NOC enable signal 136 may be sent to multiplexers 138 to reroute the data transmitted by the INIU 130 to the response buffer 134, instead of to the AXI initiator interface 132. In some embodiments, there may be one multiplexer 138 associated with every channel of communication between the INIU 130 and the AXI initiator 132. For example, in some embodiments there may be one, two, three, four, five, six, seven, eight, or any other suitable number of channels, each with an accompanying multiplexer 138 (or set of multiplexers 138). In some embodiments, other routing circuitry may be used to route the data toward the response buffer 134 based on the micro NOC enable signal 136.

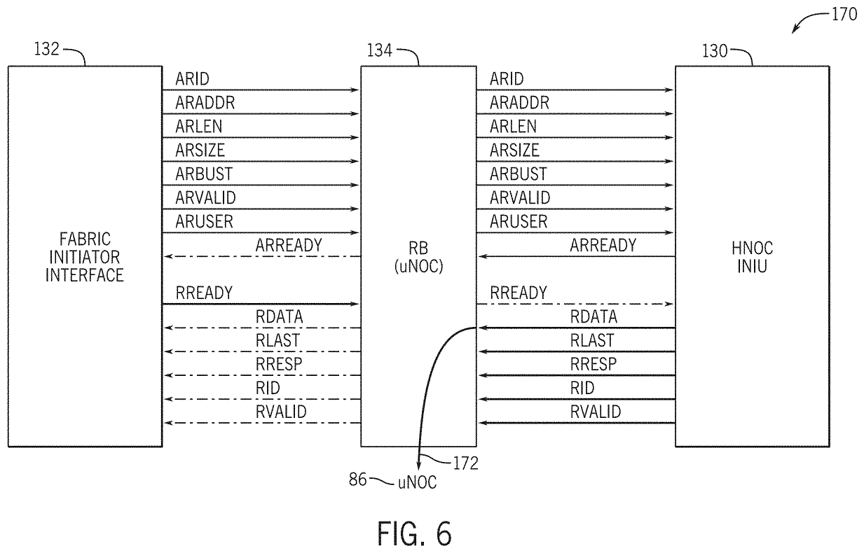

Turning now to FIG. 6, the diagram 170 illustrates further details regarding a rerouting of data from the INIU 130 to the response buffer 134. In some embodiments, an ARUSER signal may select a statically configured target memory block 84 to be read from during the data transfer. In some embodiments, the INIU 130 may transfer an RDATA signal 172 initially towards the AXI initiator interface 132 to read from the memory block 84, which would utilize soft logic of the programmable fabric 82 to transmit data. However, the response buffer 134 may intercept the RDATA signal 172 and instead transfer it to one or more micro NOCs 86, which may then read the data from the memory block 84, thereby bypassing the soft logic (because the data will be transmitted using micro NOCs 86). In some embodiments, the channel intended to send the RDATA signal 172 to the AXI initiator interface 132 may be repurposed to pack one or more read responses, for example such as RRESP, RLAST, RID, RVALID, etc. By packing multiple read responses in the channel intended to send the RDATA signal 172 to the AXI initiator interface 132, the AXI initiator interface 132 may be enabled to run at a slower rate than the micro NOC 86, which may operate at a faster speed because it may be hardened.

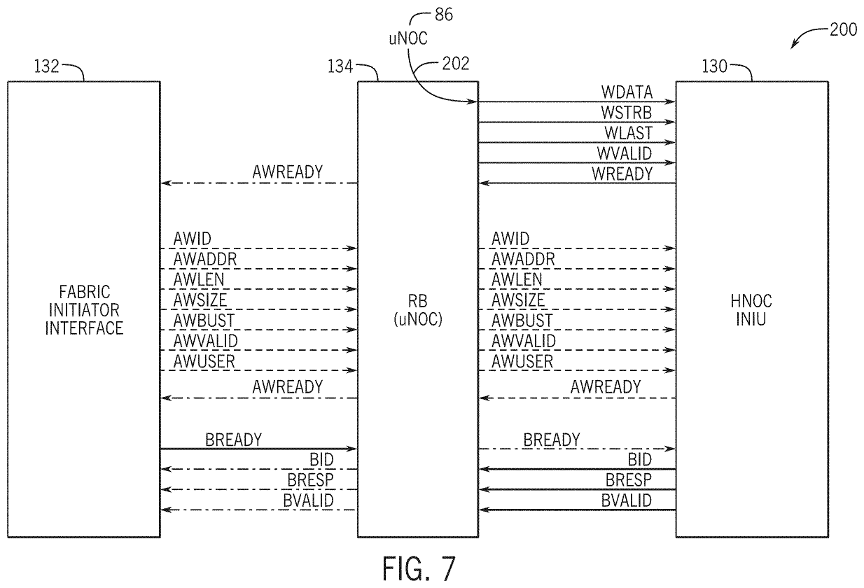

FIG. 7 illustrates an example embodiment of the response buffer 134 intercepting a write channel 202 from the micro NOC 86 and submitting it to the INIU 130. In some embodiments, the response buffer 134 may intercept the channel 202 and from it construct a write channel based on the statically configured target memory block 84A selected for the data transfer.

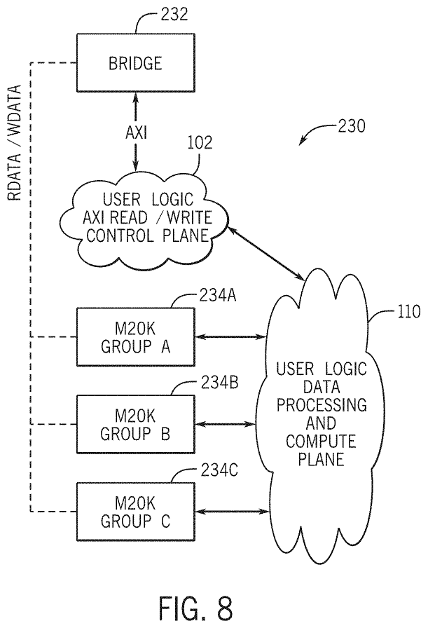

Turning now to FIG. 8, the diagram 230 illustrates a method of grouping together multiple memory blocks 84. For example, in some embodiments the user logic 102 may describe specific groupings for the memory blocks 84. In some embodiments, the groupings of the memory blocks 84 may be assigned during a design stage by a designer using the design software 14. Once grouped, the connection of groups of memory blocks 84 to the NOC 80A or the NOC 80B may be described as groups with AxUSER bindings. For example, when an AXI read/write uses a specified ARUSER/AWUSER, the AXI read/write may be directed to the specified group of fabric memories.

For example, the illustrated diagram 230 shows an example embodiment in which three groups of memory blocks 84 have been identified: group 234A, group 234B, and group 234C. When the user logic 102 specifies an ARUSER for a read or a write signal, the bridge 232 may direct the read or write signal to the group specified, (e.g., one or more of the groups 234A, 234B, or 234C). The group specified, may then interact with a user logic data processing and compute plane 110 on the programmable fabric 82, for example, to complete a requested read or write operation.

In some embodiments, the group 234A, 234B, or 234C, or any combination thereof, may group the memory blocks 84A, 84B, or 84C, or any other memory blocks, that are located adjacent to each other. For example, the group 234A may be a grouping of memory blocks 84, which may have sequential addresses.

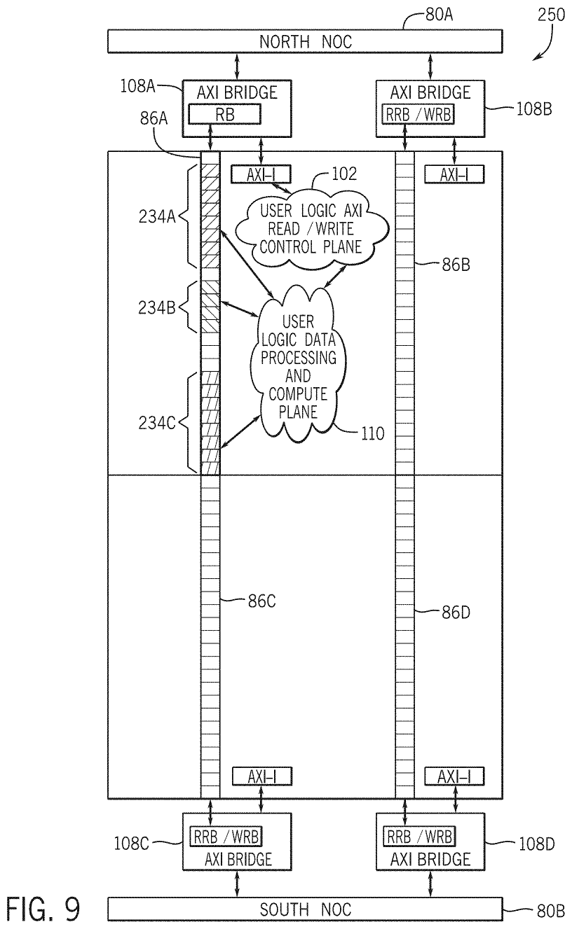

Turning now to FIG. 9, a block diagram 250 illustrates a mapping of the groups 234A, 234B, and 234C to the micro NOC 86A is described. FIG. 9 also illustrates an example embodiment of the integrated circuit device 12 including the north NOC 80A, the south NOC 80B, and four micro NOCs, 86A, 86B, 86C, and 86D dispersed in the programmable fabric 82. As illustrated, an AXI interface 108A may communicatively connect the north NOC 80A to the micro NOC 86A, the AXI interface 108B may communicatively connect the north NOC 80A to the micro NOC 86B, the AXI interface 108C may communicatively connect the south NOC 80B to the micro NOC 86C, and the AXI interface 108D may communicatively connect the south NOC 80B to the micro NOC 86D.

In some embodiments, the micro NOCs 86 (referring collectively to micro NOCs 86A, 86B, 86C, 86D, or any combination thereof) may map to a number of memory blocks 84. Additionally or alternatively, the micro NOCs 86, may map to a number of groups of memory blocks 84, such as 234A, 234B, and 234C. In the illustrated example, the micro NOC 86A is mapped to the groups 234A, 234B, and 234C. In some embodiments, other micro NOCs 86A-D may also be mapped to additional memory blocks 84 or groups of memory blocks 84. In some embodiments, the micro NOCs 86A-D may have eight thirty-two bit data path channels that map to eight 512x32 bit memory blocks 84 in parallel to create a 512x256 bit memory. However, the micro NOCs 86 may not be limited to these values, and may include a larger or smaller data path to map any suitable number of memory blocks 84 to create any suitably sized memory. Additionally, narrow mapping such as a 512x128b memory may also be supported. As noted above, the design software 14 may statically map the groups 234 (referring to groups 234A, 234B, 234C, or any combination thereof). Further, as illustrated, the groups 234 may be communicatively connected to the user logic data processing and compute plane 110.

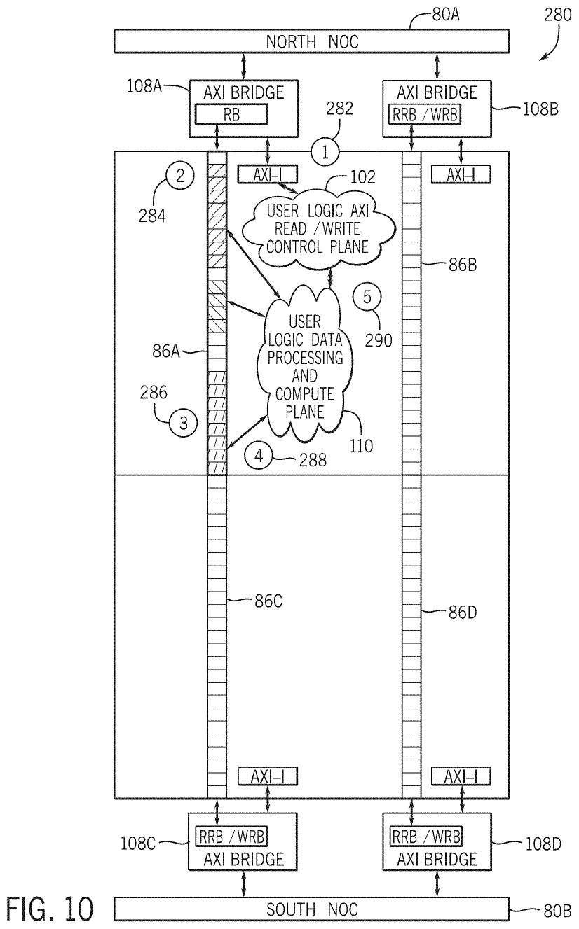

FIG. 10 is a block diagram 280 which describes several operations that may occur in the example embodiment of the integrated circuit device 12 described above with respect to FIG. 9. The operations are intended to describe an example flow of operations to accomplish a read operation from a memory block 84 via a micro NOC 86.

In a first operation 282, a read command may be sent by the user logic 102, which may specify a group 234 of memory blocks 84 to read from, as described above. In a second operation 284, an R channel (e.g., when using the AXI protocol), or other channel of another appropriate protocol, may send RDATA, or a similar request, to a micro NOC 86A. In a third operation 286, the micro NOC 86A may deposit the RDATA or similar request into the group of memory blocks 84 specified by the user logic 102. In a fourth operation 288, the micro NOC 86A may receive a signal from the group of memory blocks 84 indicating how many addresses have been read. In a fifth operation 290, the R channel may indicate completion of the read command. In some embodiments, the read response at the AXI interface 108A may pack multiple read responses to the fabric using the unused RDATA field, as described above. Further, in some embodiments, when the micro NOC 86A is not writing to the memory blocks 84, the programmable fabric 82 may write to the memory blocks 84 through soft logic of the programmable fabric 82.

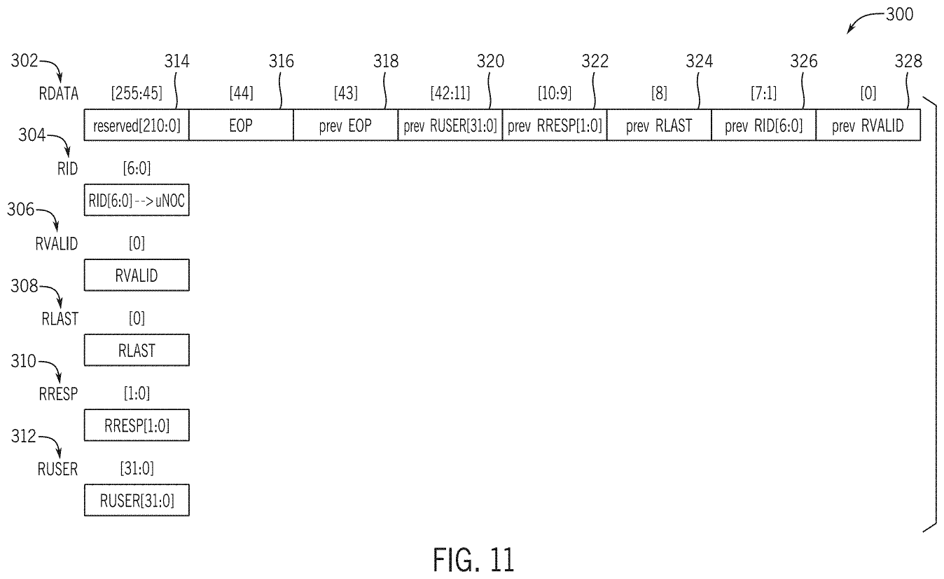

FIG. 11 includes a diagram 300 to illustrate how multiple read responses may be packed to the fabric via an unused RDATA field of the AXI protocol. For example, the diagram 300 illustrates an example spread of several AXI channels. More specifically, there may be channels 302, 304, 306, 308, 310, and 312. Further, the RDATA channel 302 may include several portions, such as portions 314, 316, 318, 320, 322, 324, 326, and 328. In some embodiments, the RDATA channel 302 may be unused because the AXI interface 108 may have rerouted data that the RDATA channel 302 would have communicated to the micro NOC 86 instead. In some embodiments, the portion 314 may be an unused portion, and may be repurposed to include two beats of a read response, including a previous read response. Further, the portions 314, 316, 318, 320, 322, 324, 326, and 328 may include other signals such as an end-of-packet signal and a previous end-of-packet signal, among other previous signals.

In some embodiments, repurposing pins of the RDATA channel 302 may enable the micro NOC 86 to operate at a faster speed than the memory blocks 84. For example, sending a previous beat of a read or write operation in the RDATA channel 302 and a current beat of the read or write operation with the other channels 304, 306, 308, 310, and 312 may enable the memory blocks 84 to run at half the frequency as the micro NOC 86. This may decouple the frequencies of the micro NOC 86 and the memory block 84. Accordingly, the micro NOCs may operate at twice the frequency of the memory blocks 84.

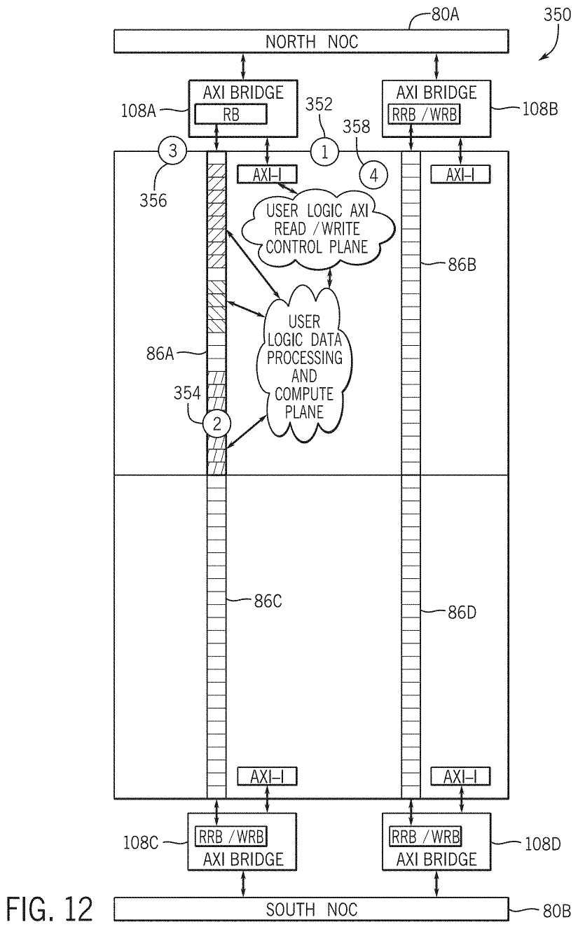

FIG. 12 includes a block diagram 350 that illustrates several operations that may occur in the example embodiment of the integrated circuit device 12 described in FIG. 9. The operations are intended to describe an example flow of operations to accomplish a write to a memory block 84 via a micro NOC 86 (e.g., micro NOC 86A).

In a first operation 352, a write command may be sent by the user logic 102, which may specify a group of memory blocks 84 to write to, as described above, as well as what data to write. In a second operation 354, the micro NOC 86A may read the data stored in the group of memory blocks 84 specified by the user logic 102. In a third operation 356, the micro NOC 86A may produce a write channel to write the data indicated by the write command to the group of memory blocks 84. In a fourth operation 358, an AXI channel may indicate completion of the write command.

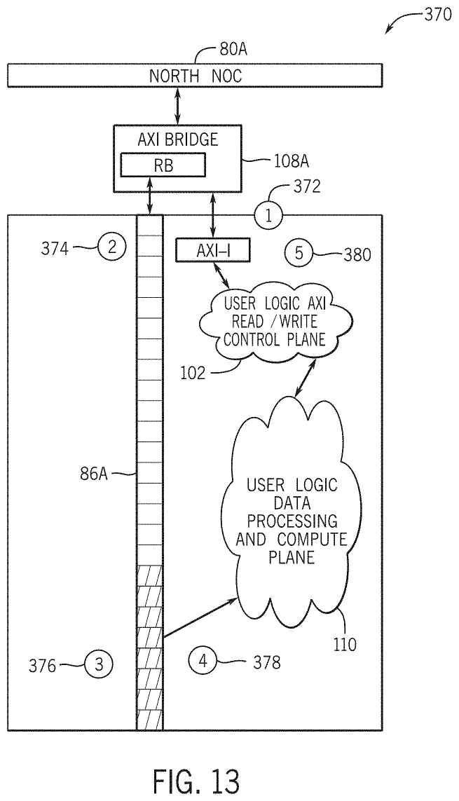

FIG. 13 illustrates a block diagram 370, which depicts an example embodiment of streaming data to or from a memory block 84 of the integrated circuit device 12. For example, in some embodiments, a first operation 372 may include sending an AXI command to gather data from a NOC 80, for example NOC 80A. In a second operation 374, an AXI channel may stream RDATA from the NOC 80A to the micro NOC 86A. In a third operation 376, the micro NOC 86A may write the RDATA to a group of memory blocks 84 specified in the AXI command at known addresses. In some embodiments, as the RDATA is being written to the group of memory blocks 84, the programmable fabric 82 may use dedicated signals from the programmable fabric 82 to indicate when the micro NOC 86A is writing the RDATA to the memory blocks 84, as well as how many addresses have been written, as in operation 378. In some embodiments, the programmable fabric 82 may track the addresses being written, and may read them out to the NOC 80A by creating a shallow first in, first out (FIFO) tunnel in soft logic of the programmable fabric 82. In some embodiments, the programmable fabric 82 may track the addresses being written via a graycode counter, which in some embodiments may track the lower two bits of the addresses being written by the micro NOC 86A. Utilizing the operations described may allow for the injection of data from the NOC 80A deep into the programmable fabric 82. Further, the graycode counter may enable faster operational speeds of the micro NOC 86A, as tracking the addresses being written to locally from the graycode counter is faster than tracking which data is being written from the AXI interface 108A. In a fifth operation 380, an AXI channel may indicate completion of the streaming, which may be communicated to the user logic 102.

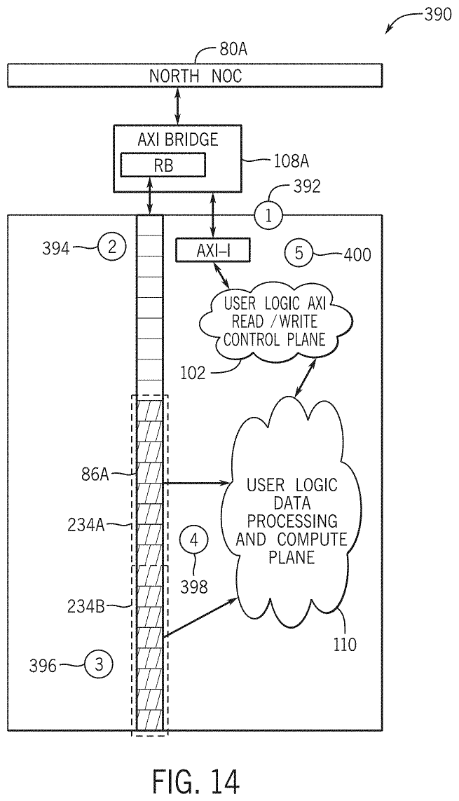

FIG. 14 illustrates another example embodiment of operations of the integrated circuit device 12. For instance, diagram 390 illustrates an example of ping pong streaming, which may stream data from two different locations of a group (e.g., a group 234) or two groups of memory blocks 84 in an alternating manner. In a first operation 392, an AXI read command may be sent to gather the data from the NOC 80A. In some embodiments, this command may specify a group of memory blocks 84 to read from, as previously described. In a second operation 394, an AXI channel may stream RDATA to the micro NOC 86A. In a third operation 396, the micro NOC 86A may alternate between writing the RDATA to two groups (e.g., groups 234A, 234B) of memory blocks 84 at known addresses. In some embodiments, such as in a fourth operation 398, the programmable fabric 82 may track the addresses being used to read out the RDATA from the groups of memory blocks 84 via a graycode counter, as described above. In a fifth operation 400, an AXI channel may indicate completion of the streaming command, which may be communicated to the user logic 102. In some embodiments, the alternation between writing the RDATA to two groups of memory blocks 84 may enable the programmable fabric 82 to perform read operations at half the frequency of the micro NOC 86A frequency.

In some embodiments, there may be more groups of memory blocks 84 that are alternatively read from, which may result in even faster micro NOC 86 operation speeds. For example, in embodiments with four groups of memory blocks 84, the micro NOC 86A may operate four times as fast as the programmable fabric 82. Any suitable number of groups of memory blocks 84 may be read from in alternating fashion to achieve the desired speed of operations of the micro NOC 86A.

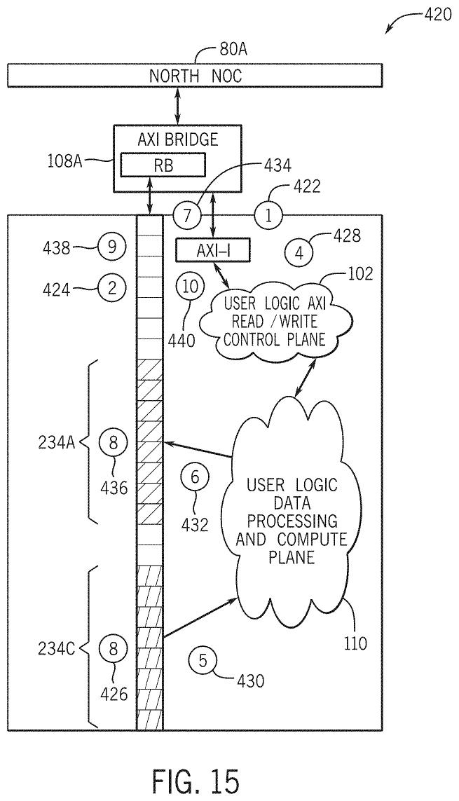

FIG. 15 illustrates another example embodiment of operations of the integrated circuit device 12. More specifically, FIG. 15 includes a diagram 420 illustrating memory paging. In some embodiments, the micro NOC 86A may fill the entire memory contents in a targeted group 234, for example, the group 234C. In other embodiments, the micro NOC 86A may fill a subset of the memory contents of the targeted group 234C. In some embodiments, after filling the memory blocks 84 in the group 234C, the group 234C may consume the contents and produce new memory content. In some content, the new memory content may go to a different group 234, for example, the group 234A. In some embodiments, the new memory content may stay in the same group 234C rather than going to the group 234A. In some embodiments, an AXI write command may be slowed from the micro NOC 86A to move the new memory content to the north NOC 80A. In some embodiments, this movement may provide a memory paging mechanism that may not involve soft logic of the fabric memory 82.

To accomplish this, a first operation 422 includes an AXI command sent from the user logic 102 to gather data from the NOC 80A. A second operation 424 includes an AXI channel streaming RDATA to the micro NOC 86A. A third operation 426 includes writing the RDATA to a group 234, for example the group 234C. A fourth operation 428 includes an AXI R channel indicating completions(s) of the operation 426, which may be communicated to the user logic 102. A fifth operation 430 includes consuming the data by the user logic data processing and compute plane 110. A sixth operation 432 may include the user logic data processing and compute plane 110 producing new data content, which in some embodiments may be stored in a new group 234, for example the group 234A, or may be stored in the group 234C. A seventh operation 434 includes an AW command being sent from the user logic 102 with instructions to scatter data to the NOC 80A. An eighth operation 436 includes the micro NOC 86A reading the new data from the group 234A (or 234C). A ninth operation 438 includes producing a write AXI channel from the micro NOC 86A to the NOC 80A. A tenth operation 440 includes an AXI channel indicating completion of the ninth operation 438, which may communicated to the user logic 102.

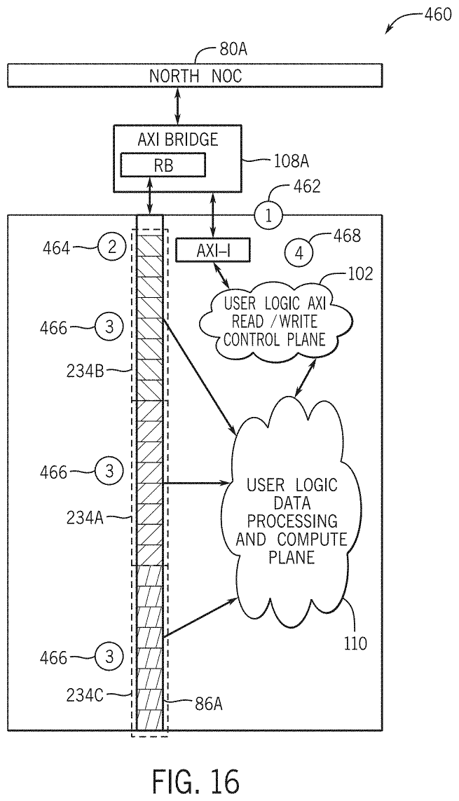

FIG. 16 illustrates a diagram 460 that depicts an example of multicasting. In the example embodiment, a first operation 462 includes sending a read command from the user logic 102 to gather data from the NOC 80A. A second operation 464 includes an AXI channel streaming RDATA from the NOC 80A to the micro NOC 86A. A third operation 466 includes simultaneously writing the RDATA to several groups 234, for example, to the groups 234A, 234B, 234C. A fourth operation 468 includes an AXI channel indicating completion, which may be communicated to the user logic 102.

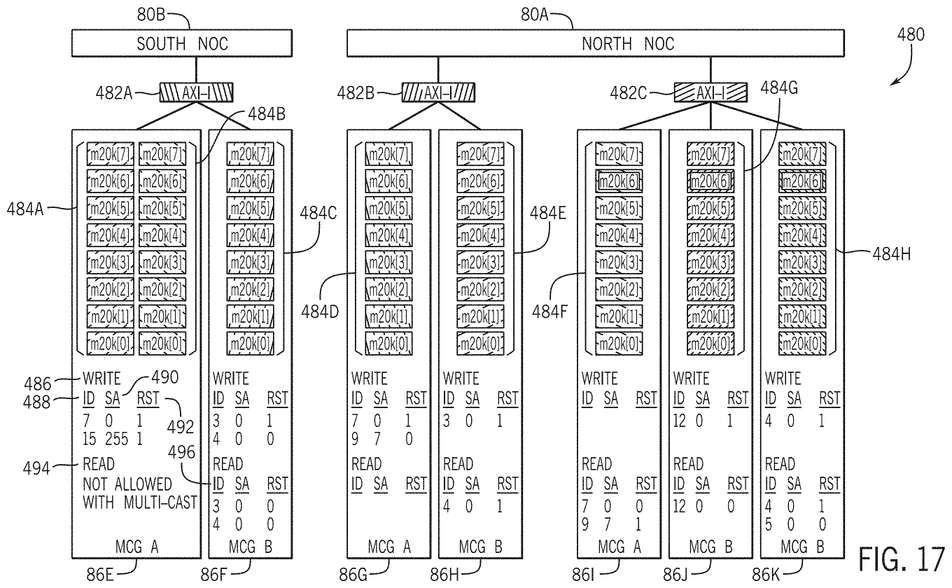

Keeping the foregoing in mind, FIG. 17 shows a diagram 480, which illustrates example micro NOC 86 transaction descriptors, which may be used in a design stage (for example, using QUARTUS) to place and configure the micro NOCs 86. In the illustrated embodiment, the south NOC 80B is communicatively coupled to an AXI interface 482A, and the north NOC 80A may be communicatively coupled to AXI interfaces 482B, 482C. Further, the AXI interface 482A may be communicatively coupled to two micro NOCs: micro NOCs 86E and 86F. The micro NOC 86E may be mapped to two groups 484A, 484B of memory blocks 84, and the micro NOC 86F may include group 484C of memory blocks 84.

The AXI interface 482B may be connected to two micro NOCs 86G and 86H, which may respectively include groups 484G, 484F of memory blocks 84. Further, the micro NOCs 86G and 86H may each include a multicast group. The AXI interface 482C may be connected to three micro NOCs 86I, 86J, and 86K, which may include groups 484F, 484G, and 484H of memory blocks 84, respectively. Further, the micro NOCs 86I, 86J, 86K may each include a multicast group.

In some embodiments, the micro NOCs 86 (referring to one or more of the NOCs 86E, 86F, 86G, 86H, 86I, 86J, 86K) that are mapped to one or more groups 484A, 484B, 484C, 484D, 484E, 484F, 484G, 484H may be considered a multicast group. Each multicast group may include of one or more of the groups 484A-484H that may be the same size. Further, each multicast group may be written such that each of the groups 484A-484H in the multicast group are written at the same time. Further, in some embodiments, only multicast groups with a single group 484A-H may be read. The multicast groups may be defined by a designer using the design software 14.

Further, in some embodiments, each multicast group may include a micro NOC transaction descriptor associated with the micro NOC 86 comprising the multicast group. Each micro NOC 86E-86K may have read and write transaction descriptor 486 and 494, which in some embodiments may match read and write IDs in an AXI or other appropriate protocol. For example, each micro NOC 86E-K may have a write ID 488 and a read ID 496. Further, each transaction descriptor may define a starting address (SA) 490 if in a reset mode (e.g., when “RST” has a value of one). The starting address 490 may be ignored if in a FIFO mode (e.g., when “RST” has a value of zero). In a reset mode 492, a data transaction may start at the starting address 490. In a FIFO mode, a data transaction may start at the next available address (e.g., the address following the last address used by the group 484A-H associated with the micro NOC 86E-K). In an example embodiment, the micro NOC 86E may be associated with the groups 484A, 484B. Further, if both of the groups 484A, 484B are in a FIFO mode, then the micro NOC 86E may perform read/write operations at the next available address for each of the groups 484A, 484B, respectively. In some embodiments, the next available address for a particular micro NOC 86 may be an address that immediately follows the last address utilized by a local micro NOC controller that may be included in a memory block 84.

In some embodiments, the IDs 488, 496 are unique for the write operations and for the read operations in a given multicast group. Additionally, in some embodiments the IDs 488 may not be unique between reads and writes, such that a write ID 488, (e.g., “7”), that is unique among the write IDs 488 in a given multicast group may share a common ID number (e.g., “7”) with a read ID 496 in the given multicast group. Further, in some embodiments there may be at least one read transaction and one write transaction in any given multicast group.

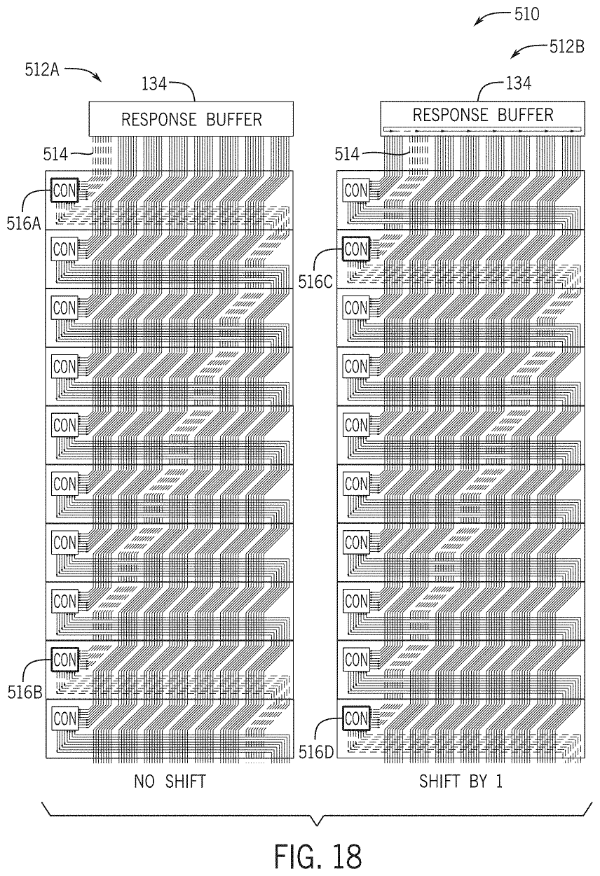

FIG. 18 depicts a block diagram 510 showing an embodiment of AXI channels connecting the response buffer 134 to the micro NOCs 86A-86K. In some embodiments, these channels depict a micro NOC bus. In some embodiments, there are eight channels, although there may be more or fewer channels. In some embodiments, fewer than eight memory blocks 84 may be written in parallel. In some embodiments, the AXI channels may send out beats of a given AXI transaction that may be split into a number of 32b channels (e.g., 8 channels), wherein each channel may target a respective micro NOC control 516A, 516B, 516C, or 516D. In an example embodiment, each beat of a given AXI transaction may be dispatched by the response buffer 134, which may convert an AXI read beat to a write to a given memory block 84 or group of memory blocks 84. Further, the response buffer 134 may request a read from a given memory block 84 or group of memory blocks 84 via a given micro NOC 86A-86K to perform a beat of an AXI write operation.

The example diagram 512A shows no shift from the response buffer 134, where the channels may connect every eighth memory block 84. To allow for more fluid placement, in some embodiments, the response buffer 134 may barrel shift the channels as shown in the example diagram 512B. For example, the data 514 may be shifted to the right by one channel. In some embodiments, the channels may pass through micro NOC controls 516A, 516B, 516C, 516D. In the example 512A, data 514 may pass through the micro NOC controls 516A and 516B to be routed to or from one or more memory blocks 84. In the example 512B, the data 514 may pass through the micro NOC controls 516C and 516D to be routed to or from one or more memory blocks 84.

In some embodiments, read operations may be achieved using a wrap-around, where the response buffer 134 may indicate the read of the memory blocks 84. The contents may then be wrapped around on a ring structure and returned to the response buffer 134. In some embodiments, the wrap-around point may be statically configurable. In such embodiments, the wrap-around may be dynamic and may occur at the point of the memory block 84 read by a micro NOC 86.

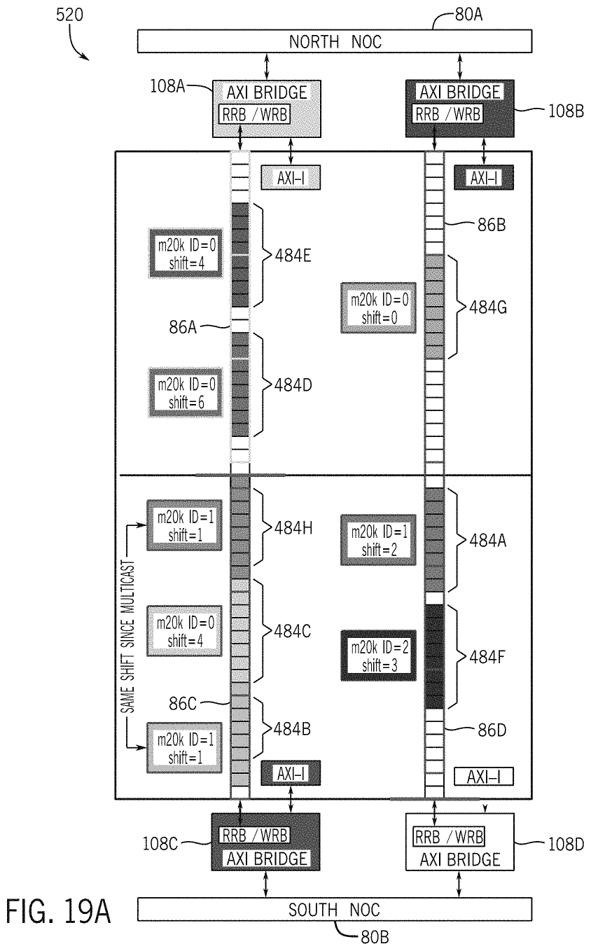

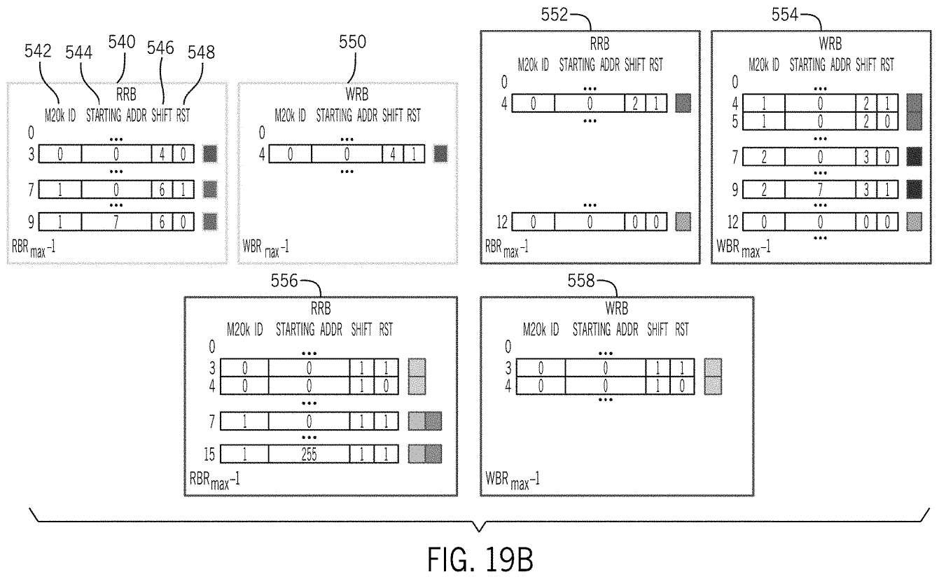

FIG. 19A shows an example embodiment of an integrated circuit 520 (e.g., the integrated circuit device 12) with a mapping of the groups 484A-H as defined in FIG. 18. In some embodiments the integrated circuit 520 may include the north NOC 80A connected to the AXI interface 108A associated with the micro NOC 86A, as well as the AXI interface 108B associated with the micro NOC 86B. Further, in some embodiments the integrated circuit 520 may include the south NOC 80B, connected to the AXI interface 108C associated with the micro NOC 86C, as well as the AXI interface 108D associated with the micro NOC 86D. In some embodiments, there may be a split point between the micro NOC 86A and 86C, as well as the micro NOC 86B and 86D. In some embodiments the split point may be hardened for the two directions and may be statically configured (e.g., using the design software 14).

In some embodiments, the micro NOCs 86A, 86C may instead be a single micro NOC, and the micro NOCs 86B, 86D may also be a single micro NOC. Further, in embodiments where there is no split point, the memory blocks 84 associated with the micro NOCs 86A-86D may be accessed from either direction (north or south).

In some embodiments, the design software 14 may map the groups 484A-H according to the restrictions of the associated AXI interface 108, micro NOC 86, and physical channel structure.

FIG. 19B illustrates example embodiments of transaction descriptors used to map groups 484A-484H to the micro NOCs 86A-D. The response buffers 540, 550, 552, 554, 556, and 558 may be assigned transaction descriptor values by the design software 14. In some embodiments, the design software 14 may assign memory blocks 84 in the same group 484A-H the same ID, such as an ID 542. The design software 14 may assign a shift value 546 to each group 484A-484H based on its relative placement to the physical channels. In some embodiments, a response buffer 540, 550, 552, 554, 556, 558 may use the shift value 546 to barrel shift the channels, as shown in FIG. 18. Additionally, the design software 14 may assign a starting address 544 and a RST value 548 to each group 484. In some embodiments, a static configuration containing the associated transaction descriptors may be set in a respective response buffer 540, 552, 554, 556, 558. Furthermore, the associated transaction descriptors may be split into read settings in a read response buffer, such as response buffers 540, 552, and 556 and write settings in a write response buffer, such as response buffers 550, 554, and 558. In some embodiments, these read and write settings may be configured as memory mapped registers.

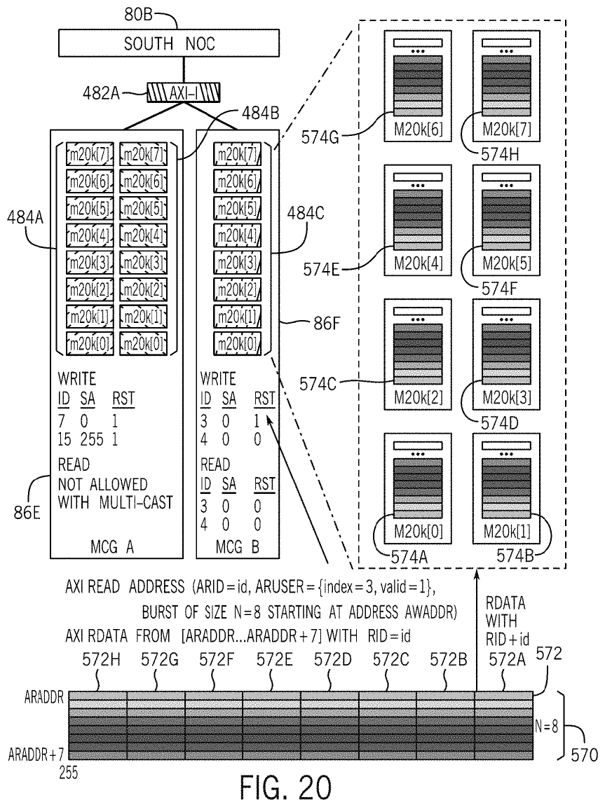

FIG. 20 shows an invocation of an AXI read targeted to a multicast group. In the illustrated example, the south NOC 80B is connected to the AXI interface 108C, which is communicatively coupled to micro NOC 86E (which may include a multicast group including groups 484A and 484B) and micro NOC 86F (which may include a multicast group including group 484C). In some embodiments, the groups 484A-484C may include a number of memory blocks 84, and each memory block 84 may include a number of addresses 574. For example, in an embodiment in which there are eight memory blocks 84 in the groups 484C, there may be eight starting addresses (e.g., address 0), respectively labeled 574A, 574B, 574C, 574D, 574E, 574F, 574G, 574H, Thus, there may be one starting address for each of the eight memory blocks 84 included in each group 484.

In some embodiments, a set of RDATA 570 may include at least a first RDATA 572, which may include data blocks 572A, 572B, 572C, 572D, 572E, 572F, 572G, and 572H. In some embodiments, the read may be transformed into a streaming write to the group 484C. For example, the read from the NOC 80B memory space may be streamed into the group 484C based on the ID and starting address from the transaction descriptors of the micro NOC 86F. For example, the data in the data block 572A may be written to the address 574A of a first memory block 84 of the group 484C, the data in the data block 572B may be written to the address 574B of a second memory block 84 of the group 484, and so forth until the entire RDATA 572 has been written to the group 484C. Further, a second, third, fourth, and other RDATA of the set of RDATA 570 may similarly be written to subsequent addresses of the memory blocks 84 of the group 484C. In some embodiments, the address may wrap around from the top address back to 0 (not shown).

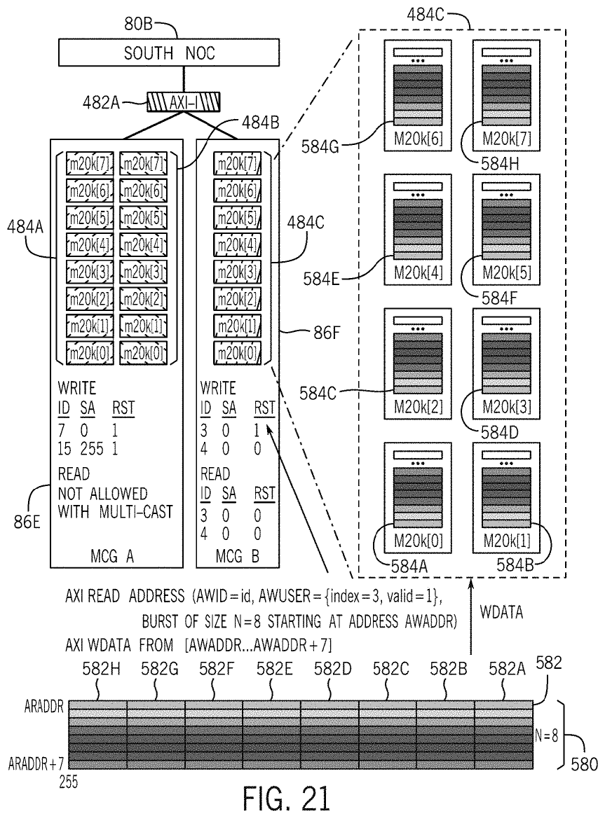

FIG. 21 shows an invocation of an AXI write targeted to a multicast group. Data to be written, WDATA 580, may include a first set of data WDATA 582, which may include data blocks 582A, 582B, 582C, 582D, 582E, 582F, 582G, 582H, which may be written to using data from respective memory addresses 584A, 584B, 584C, 584D, 584E, 584F, 584G, 584H of the memory blocks 84 of the group 484C. Further, a second, third, fourth, and other sets of data (e.g., WDATA) of the WDATA 580 may similarly be written utilizing the data from subsequent addresses of the memory blocks 84 of the group 484C.

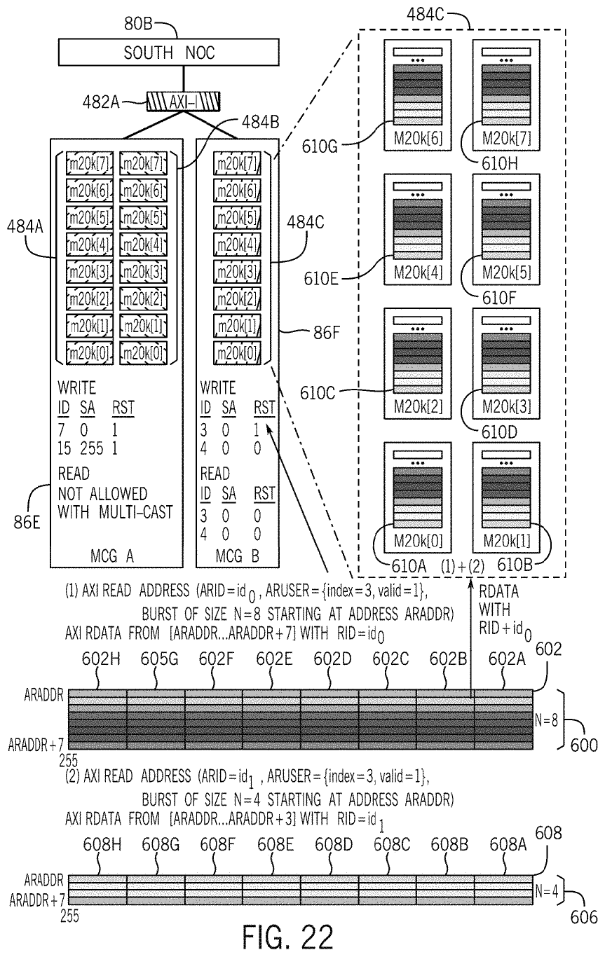

FIG. 22 shows an invocation of an AXI read operation in a reset mode of operation. Initially, a write operation may be performed on the group 484C, as described in FIG. 20. For instance, a set of RDATA 600 may include a first RDATA 602 with data blocks 602A, 602B, 602C, 602D, 602E, 602F, 602G, and 602H. As described above, these data blocks may be read from the group 484C, as well as the rest of the set of RDATA 600.

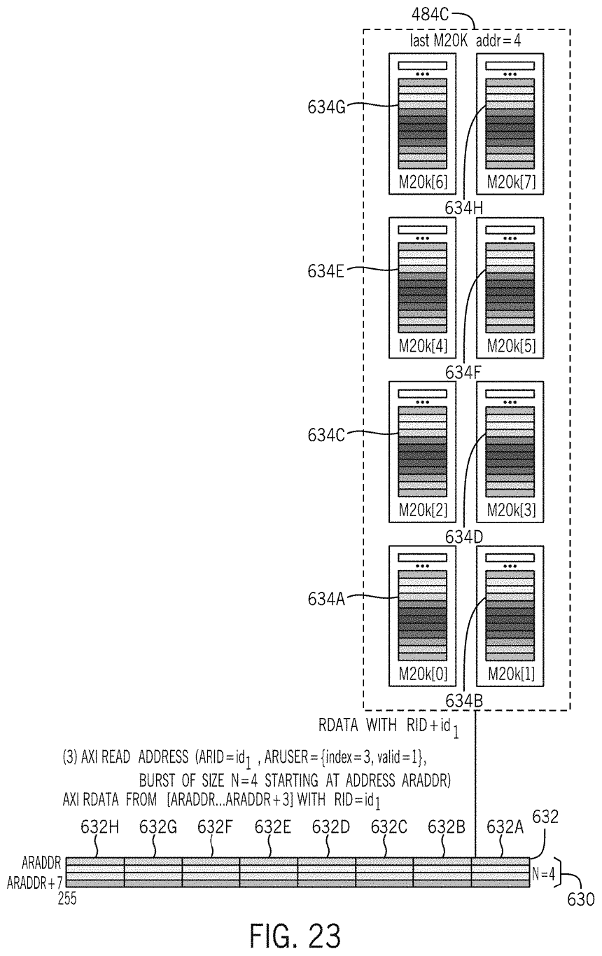

Further, in the reset mode, a second transaction may occur. For example, in some embodiments after the RDATA 600 has been read from the group 484C, a second read operation may occur, such that a set of RDATA 606 may be read from the group 484C (e.g., starting at the same position as a previous read operation). The set of RDATA 606 may include a first RDATA 608, which may have data blocks 608A, 608B, 608C, 608D, 608E, 608F, 608G, 608H. As opposed to reading values from memory blocks 84 starting where the first operation ended (as discussed below with respect to a FIFO mode of operation and FIG. 23), in the reset mode, data may be read from a same starting point (e.g., same memory address) as the preceding (read) operation. In some embodiments, using multiple starting addresses may allow for portions of the group 484C to be used in a ping pong buffering method.

FIG. 23 illustrates an example embodiment of a read operation in a FIFO mode of operation (as opposed to the reset mode illustrated in FIG. 22). In some embodiments, a second transaction may include writing a set of RDATA 630 to the group 484C. In some embodiments, the set of RDATA 630 may include a first RDATA 632, which may have data blocks 632A, 632B, 632C, 632D, 632E, 632F, 632G, and 632H. In the FIFO mode, these addresses may be read starting where the previous (read) transaction ended. For example, in an embodiment where the first transaction read data for the first eight addresses of each memory block 84 of the group 484C, in a FIFO mode the second write transaction may begin at an ninth address of each memory block 84 of the group 484C, for example, at addresses 634A, 634B, 634C, 634D, 634E, 634F, 634G, 634H of the eight memory blocks 84 in the group 484C.

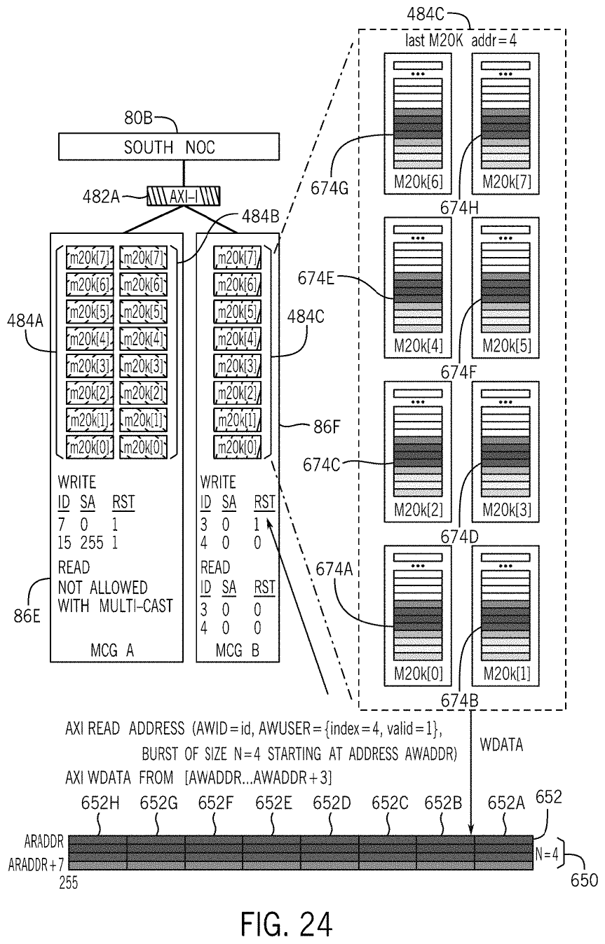

FIG. 24 illustrates an example embodiment of an AXI write operation in a FIFO mode. The illustrated embodiment may occur after the operations described in FIG. 22. In the illustrated embodiment, a set of WDATA 650 may include a first WDATA 652, which may include data blocks 652A, 652B, 652C, 652D, 652E, 652F, 652G, 652H. The data blocks 652A-H may be written to utilizing data from memory addresses 674A, 674B, 674C, 674D, 674E, 674F, 674F, 674G, 674H. In other words, data may be read from memory addresses 674A, 674B, 674C, 674D, 674E, 674F, 674F, 674G, 674H and respectively written to data blocks 652A, 652B, 652C, 652D, 652E, 652F, 652G, 652H. For example, in the FIFO mode, the data in the data block 652A of the WDATA 652 may be written to utilizing data stored in memory address 674A. Further, the data in the data block 652B may be written utilizing data stored in memory address 674B of a second memory block 84 of the group 484C, and so forth until the entire WDATA 652 has been written. Further, the rest of the set of WDATA 650 may similarly be written (e.g., by reading data from subsequent addresses of the memory blocks 84 of the group 484C).

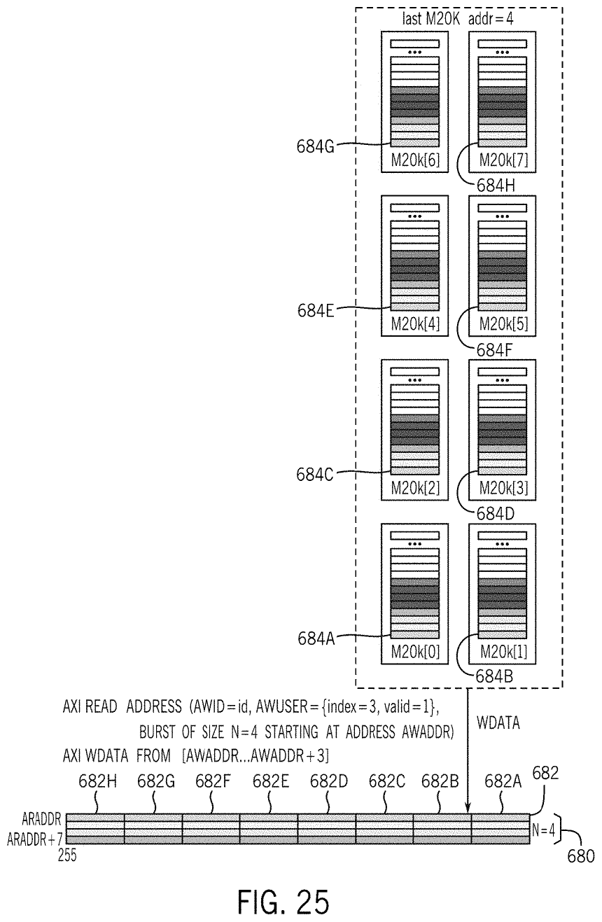

FIG. 25 illustrates an example embodiment of an AXI write operation in a reset mode. The illustrated embodiment may occur after the operations described in FIG. 22. In the illustrated embodiment, a set of WDATA 680 may include a first WDATA 682, which may include data blocks 682A, 682B, 682C, 682D, 682E, 682F, 682G, 682H. The data blocks 682A-H may be written to memory address 684A, 684B, 684C, 684D, 684E, 684F, 684F, 684G, 684H. For example, in the reset mode of operation, the write operation may begin at the first memory address, which may overwrite previously written data. For example, data at data block 682A of the WDATA 682 may be written to the address 684A of a first memory block 84 of the group 484C, the data in the data block 682B may be written to the address 684B of a second memory block 84 of the group 484C, and so forth until the entire WDATA 682 has been written to the group 484C. Further, the rest of the set of WDATA 680 may similarly be read from subsequent addresses of the memory blocks 84 of the group 484C.

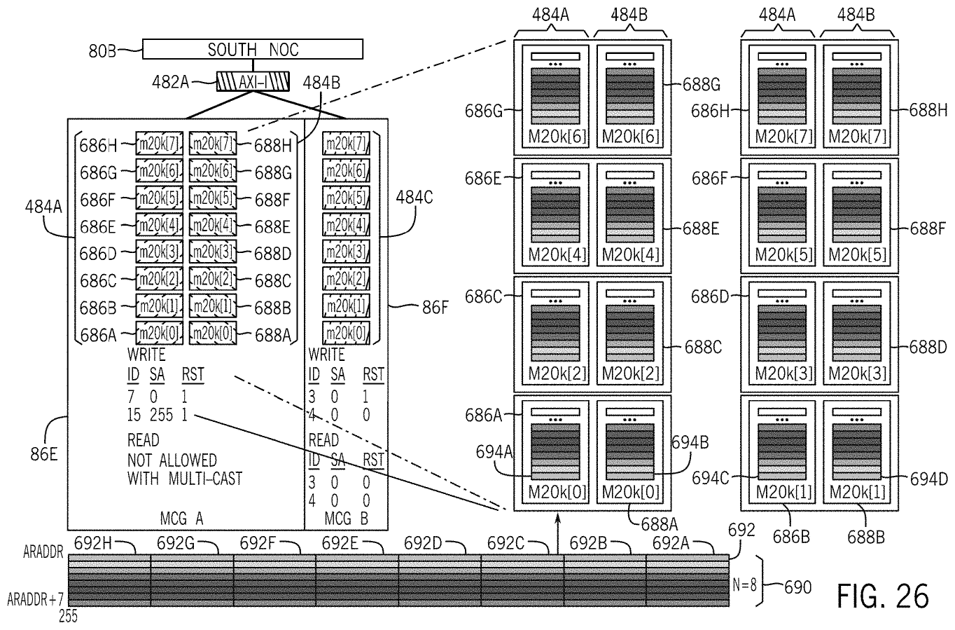

FIG. 26 illustrates an example embodiment of an AXI read using micro NOC multicast semantics. In the illustrated embodiment, the south NOC 80B is connected to the AXI interface 108C, which may be connected to the micro NOCs 86E and 86F. In some embodiments, the micro NOCs 86E and 86F may include multicast groups. The micro NOC 86E may include a group 484A, which may include memory blocks 686A, 686B, 686C, 686D, 686E, 686F, 686G, 686H. Additionally, the micro NOC 86E may also include a second group 484B, which may include memory blocks 688A, 688B, 688C, 688D, 688E, 688F, 688G, 688H.

In some embodiments, the two groups 484A and 484B may be written in parallel. For example, a set of RDATA 690 may include a first RDATA 692, which may include data blocks 692A, 692B, 692C, 692D, 692E, 692F, 692G, 692H. The data from the data block 692A may be streamed to both an address 694A (i.e., address 255) of the memory block 686A of the group 484A and an address 694B (i.e., address 255) of the memory block 688A of the group 484B at the same time. Further, the data from the data block 692B may be streamed to both an address 694C (i.e., address 255) of the memory block 686B of the group 484A and an address 694D (i.e., address 255) of the memory block 688B of the group 484B at the same time, and so forth until all of the set of RDATA 690 has been written.

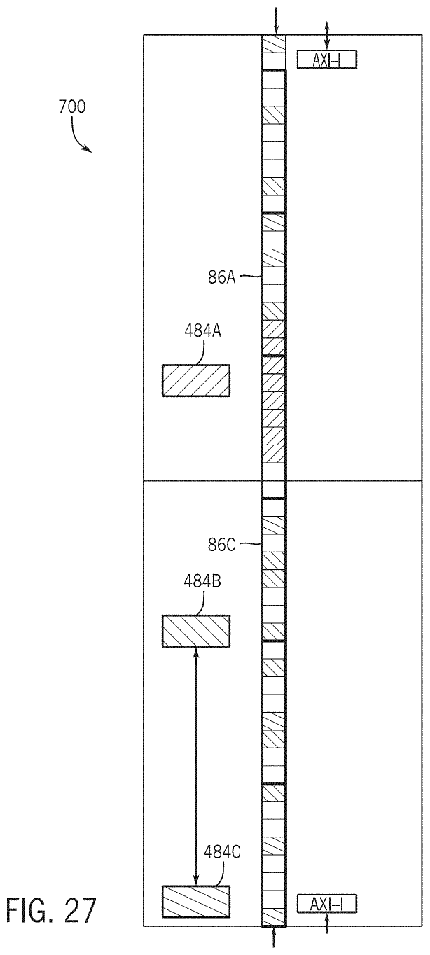

FIG. 27 is a diagram 700 illustrating an example of disaggregated mapping that may be implemented on micro NOCs 86. In particular, the diagram 700 illustrates that the micro NOCs 86A, 86C may include disaggregated groups 484A, 484B, 484C. For example, in some embodiments the memory blocks 84 that are associated with each group 484A-484C may not be sequentially located. For example, a first memory block 84 of the group 484A may be located along the micro NOC 86A, and a second memory block 84 of the group 484A may be located several addresses away from the first memory block 84. In some embodiments each memory block 84 of each group 484A-C may be discretely located, although in some embodiments there may be any grouping order. In some embodiments, each memory block 84 may have an associated channel from the bus illustrated in FIG. 18. Accordingly, data may be read and written from groups 484A-H of memory blocks 84 that are discontinuous. The groups 484A-H may be specified by a designer using the design software 14.

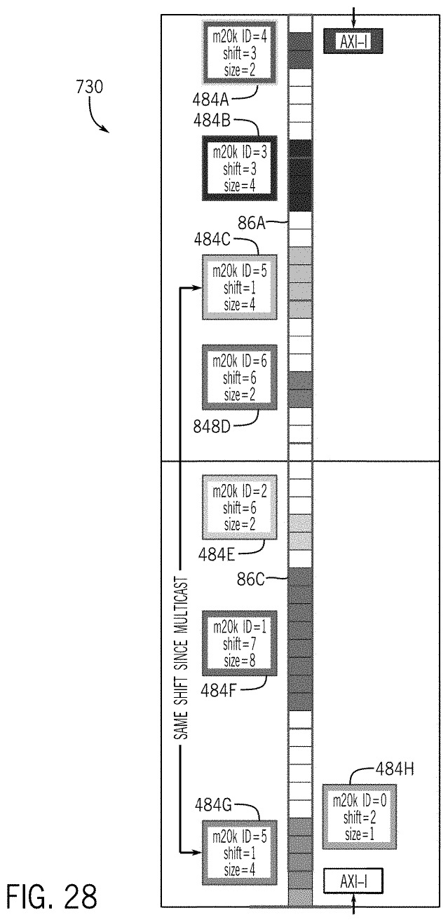

FIG. 28 illustrates a mapping 730 of different sized groups 484A-H. The mapping 730 illustrates how the micro NOCs 86A and 86C may include groups 484A-484H, which may include different amounts of memory blocks 84. As illustrated, the group 484A may include two memory blocks 84, the group 484C may have four memory blocks, the group 484F may have eight memory blocks 84. In some embodiments, groups 484A-484H that may be smaller than the number of channels. Further, in the size of the groups 484A-484H may be configured in a respective read response buffer or write response buffer to shape the micro NOC 86 transactions. As such, a designer may utilize the design software 14 to define any suitable number of groups 484, with each group 484A-H including a desired number of memory blocks 84.

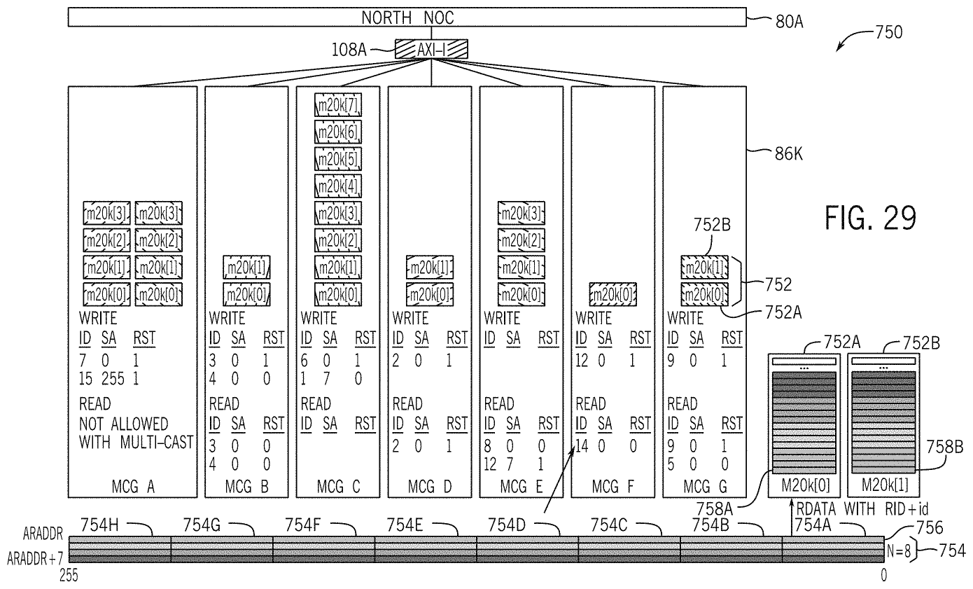

FIG. 29 illustrates an example embodiment of differently sized AXI read operations using micro NOC streaming semantics. In the diagram 750, the north NOC 80A is connected to the AXI interface 108A, which is connected to at least the micro NOC 86K. In the illustrated embodiment, the micro NOC 86K includes a multicast group including group 752 of memory blocks 84, which is made up of two memory blocks 84 (e.g., memory block 752A and memory block 752B).

In a read operation, RDATA 754 may include have four sets of data, including a first set of RDATA 756. The RDATA 756 may include data blocks 754A, 754B, 754C, 754D, 754E, 754F, 754G, 754H. In the example embodiment, the RDATA 754 may be streamed to the memory blocks 752A and 754B in alternating fashion. For example, the data at data block 754A may be streamed to an address 758A of memory block 752A, and then the data at data block 754B may be streamed to an address 758B of the memory block 752B. Further, the data at data block 754C may be streamed to the next address of the memory block 752A, the data at data block 754D may be streamed to the next address 758B of the memory block 752B, and so forth until all of the RDATA 756 has been streamed. The remaining data in the RDATA 754 may be streamed following a similar pattern.

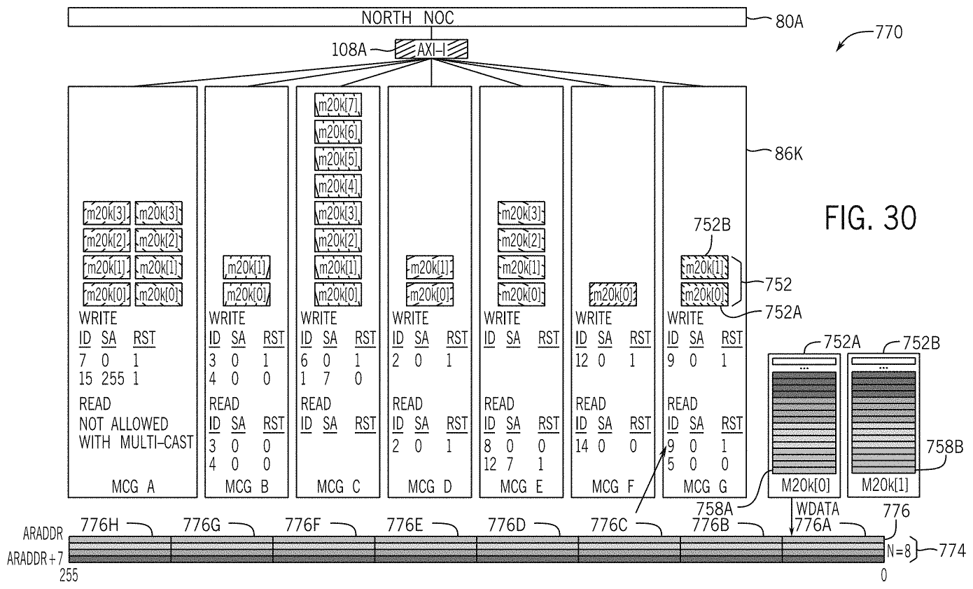

FIG. 30 is a diagram 770 illustrating an example embodiment of differently sized AXI write operations using micro NOC streaming semantics. In a write operation of the diagram 770, WDATA 774 may include four sets of data to be written, including a first set of WDATA 776. The WDATA 776 may include data blocks 776A, 776B, 776C, 776D, 776E, 776F, 776G, 776H. In the example embodiment, the WDATA 776 may be streamed to the memory blocks 752A and 754B in alternating fashion. For example, the data at data block 776A may be streamed to an address 758A of memory block 752A, and then the data at data block 776B may be streamed to an address 758B of the memory block 752B. Further, the data at data block 776C may be streamed to the next address of the memory block 752A, the data at data block 776D may be streamed to the next address 758B of the memory block 752B, and so forth until all of the WDATA 776 has been streamed. The remaining data in the WDATA 774 may be streamed following a similar pattern. In some embodiments, fabric groups of larger sizes may be supported.

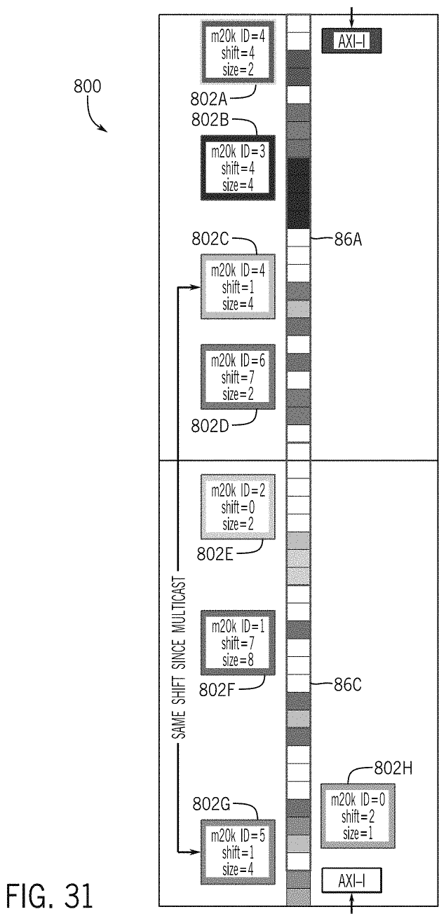

FIG. 31 illustrates an example embodiment of a mapping 800 that includes differently sized and disaggregated groups 484. In particular, the mapping 800 illustrates how the micro NOCs 86A and 86C may include groups 802A, 802B, 802C, 802D, 802E, 802F, 802G, 802H of memory blocks 84, which may include varying amounts of memory blocks 84 and either be contiguous (e.g., aggregated) or discontinuous (e.g., disaggregated). In other words, the number of memory blocks 84 included in each group 802A-802H may not be equal. For example, the group 802A may have two memory blocks 84, while the group 802B may have four memory blocks 84. Further, in some embodiments the memory blocks 84 that are associated with each group 802A-802H may not be sequentially located. For example, a first memory block 84 of the group 802D may be located along the micro NOC 86A, and a second memory block 84 of the group 802D may be located several addresses away from the first memory block 84. In some embodiments each memory block 84 of each group 802A-802H may be discretely located, although in some embodiments there may be any grouping order. In some embodiments, each memory block 84 may have an associated channel from the bus illustrated in FIG. 18. Accordingly, a designer may utilize the design software 14 to generate groups 802A-H that may include any desired amount of memory blocks 84 that are located along micro NOCs 86 (or a single micro NOC 86) in any desired pattern (e.g., an aggregated pattern or a disaggregated pattern).

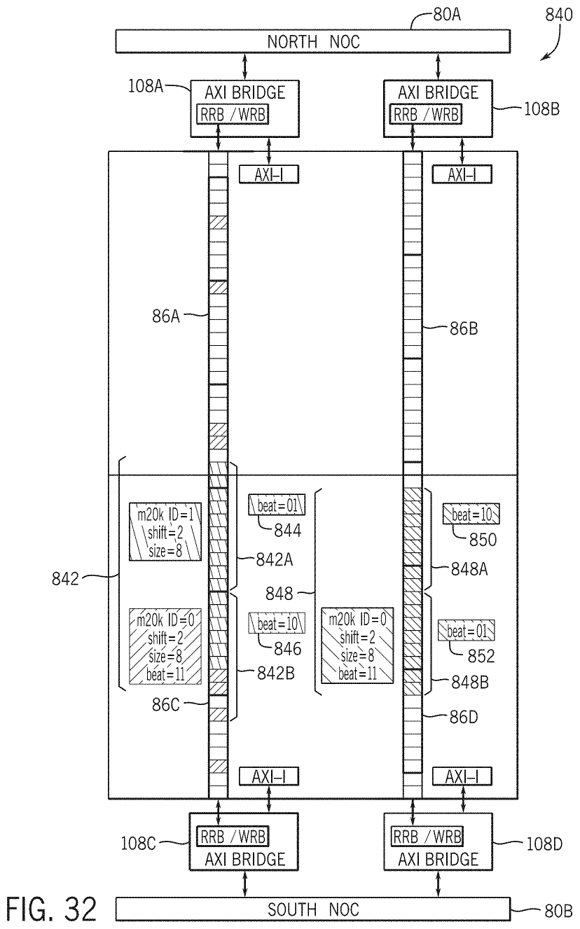

Continuing with the drawings, FIG. 32 illustrates a mapping 840 of ping-ponging groups (e.g., groups 842, 848) of memory blocks 84. As illustrated, the mapping 840 includes the north NOC 80A that is connected to the AXI interface 108A associated with the micro NOC 86A, as well as the AXI interface 108B associated with the micro NOC 86B. Further, in some embodiments the integrated circuit 520 may include the south NOC 80B, connected to the AXI interface 108C associated with the micro NOC 86C, as well as the AXI interface 108D associated with the micro NOC 86D.

In some embodiments, the groups 842, 848 may have sizes that are wider than the channels of the bus may support. To enable support for larger groups such as this, a ping-ponging operation may be utilized. In some embodiments, the groups 842, 848 may be mapped and configured such that the first portion of each of the groups 842, 848 (e.g., memory blocks 842A for the group 842 and memory blocks 848A for the group 848) may be read from or written to on one cycle and the second portion of each group 842 and 848 (memory blocks 842B for group 842 and memory blocks 848B for group 848) are read from or written to on the next cycle, and so forth. In some embodiments, the group 842 may be configured (e.g., as indicated by a designer using the design software 14) with beats 844 and 846, and the group 848 may be configured with beats 850 and 852 to indicate which portion of the group is read or written in a particular cycle. In some embodiments, there may be more than two beats. In some embodiments, the beats may be configured using CRAM. Thus, the while FIG. 32 illustrates the groups 842, 848 including two portions that are written to or read from in alternating cycles, in other embodiments, groups may include more than two portions that may be read from or written to in a cyclical manner.

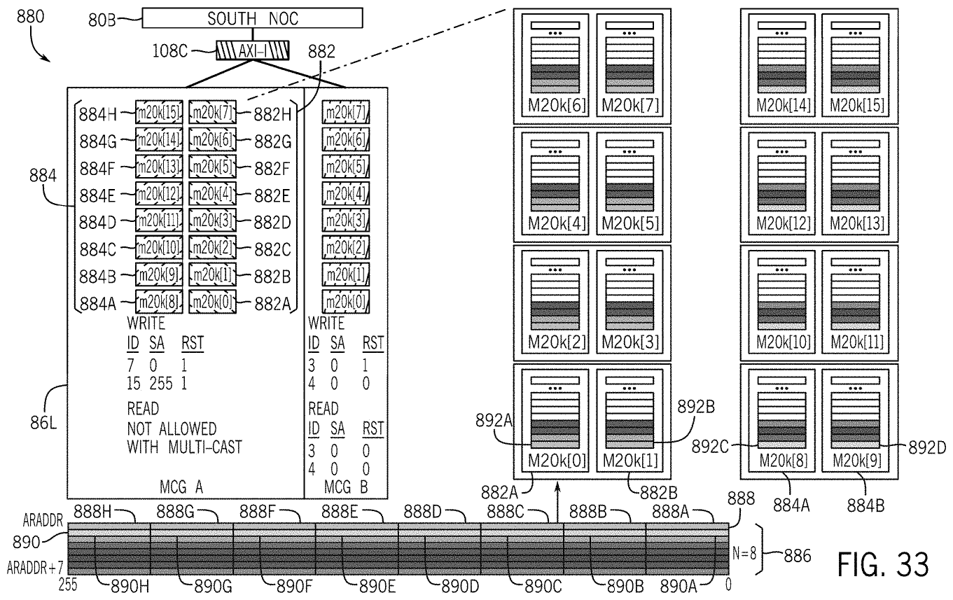

FIG. 33 illustrates an example embodiment of performing an AXI read using micro NOC ping pong semantics. As illustrated, a system 880 includes the south NOC 80B, which may be connected to the AXI interface 108C. Further, the AXI interface 108C may be connected to at least the micro NOC 86L. Further, in the illustrated embodiment, the micro NOC 86L includes a multicast group with groups 882 and 884. In some embodiments, the group 882 may include memory blocks 882A and 882B, which may each include memory addresses, including a zero position memory address 892A and 892B, respectively. Further, the group 884 may include memory blocks 884A and 884B, which may each include memory addresses, including respective zero position memory addresses 892C, 892D.

In a read operation, a set of RDATA 886 may include a first RDATA 888, and may have sets of data. The RDATA 888 may include data blocks 888A, 888B, 888C, 888D, 888E, 888F, 888G, and 888H. The RDATA 888 may be streamed to the group 882. For example, the data at data block 888A may be streamed to the address 892A of memory block 882A, and then the data at data block 888B may be streamed to an address 892B of the memory block 882B. Further, the remaining data in the RDATA 888 may similarly be read to the remaining memory blocks in group 882. Further, the set of RDATA 886 may include a second RDATA 890, which may include data blocks 890A, 890B, 890C, 890D, 890E, 890F, 890G, and 890H. These may be streamed into the group 884. For example, the data at the data block 890A may be streamed to the address 892C of memory block 884A, and then the data at the data block 890B may be streamed to an address 892D of the memory block 884B. Further, the remaining data in the RDATA 890 may similarly be read to the remaining memory blocks in group 884. Accordingly, data may be read from memory addresses of different memory blocks 84 included in different groups of the memory blocks 84.

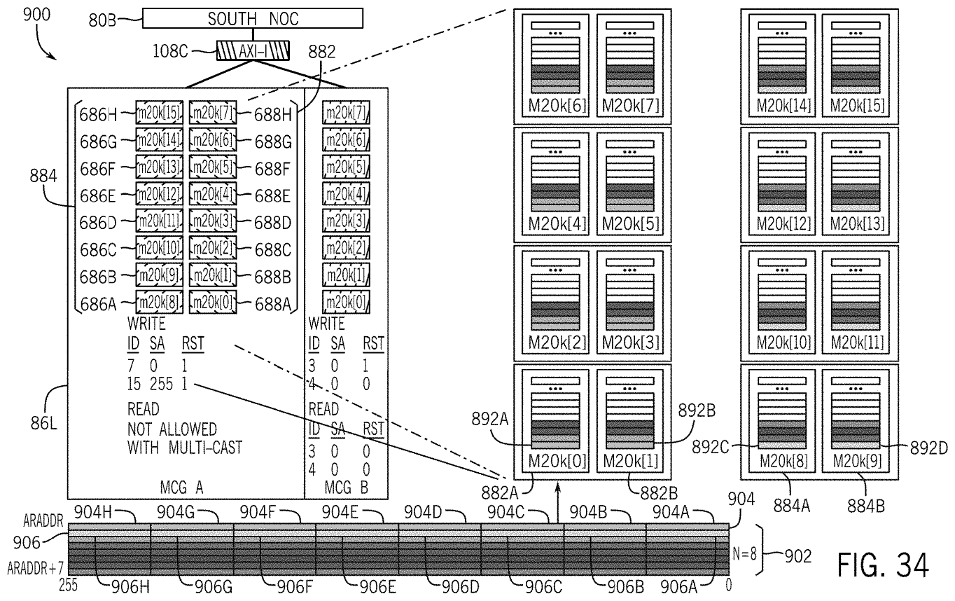

FIG. 34 illustrates an example embodiment of performing an AXI write using micro NOC ping pong semantics. In the illustrated embodiment, system 900 may include the same components as the system 880 described in FIG. 33. However, instead of reading data, data to be written (e.g., WDATA 902) is illustrated. WDATA 902 may include a first set of data, WDATA 904, and may include eight total sets of data. The WDATA 904 may include data blocks 904A, 904B, 904C, 904D, 904E, 904F, 904G, 904H. The WDATA 904 may be streamed from the group 882 (e.g., by utilizing the data stored in memory blocks 688A, 688B, 688C, 688D, 688E, 688F, 688G, 688H). For example, the data at data block 904A may be streamed from the address 892A of memory block 882A, and then the data at data block 904B may be streamed from an address 892B of the memory block 882B. Further, the remaining data in the WDATA 904 may similarly be generated by reading from the remaining memory blocks in group 882. Further, the set of WDATA 902 may include a second set of WDATA 906 that includes data blocks 906A, 906B, 906C, 906D, 906E, 906F, 906G, 906H. The data may be streamed from the group 884. For example, the data at the data block 906A may be streamed from the address 892C of memory block 884A, and then the data at the data block 906B may be streamed from an address 892D of the memory block 884B. Further, the remaining data in the WDATA 902 may similarly be read from the remaining memory blocks in the group 884.

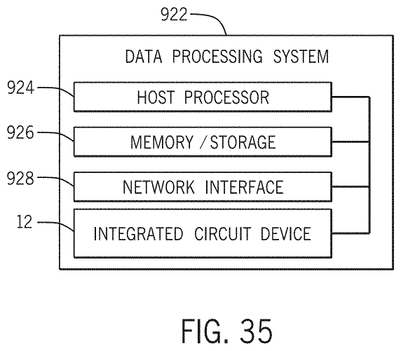

Keeping the foregoing in mind, the integrated circuit device 12 (e.g., integrated circuit device 12A) may be a part of a data processing system or may be a component of a data processing system that may benefit from use of the techniques discussed herein. For example, the integrated circuit device 12 may be a component of a data processing system 922, shown in FIG. 35. The data processing system 922 includes a host processor 924, memory and/or storage circuitry 926, and a network interface 928. The data processing system 922 may include more or fewer components (e.g., electronic display, user interface structures, application specific integrated circuits (ASICs)).

The host processor 924 may include any suitable processor, such as an INTEL® XEON® processor or a reduced-instruction processor (e.g., a reduced instruction set computer (RISC), an Advanced RISC Machine (ARM) processor) that may manage a data processing request for the data processing system 922 (e.g., to perform machine learning, video processing, voice recognition, image recognition, data compression, database search ranking, bioinformatics, network security pattern identification, spatial navigation, or the like). The memory and/or storage circuitry 926 may include random access memory (RAM), read-only memory (ROM), one or more hard drives, flash memory, or the like. The memory and/or storage circuitry 926 may be considered external memory to the integrated circuit device 12 and may hold data to be processed by the data processing system 922 and/or may be internal to the integrated circuit device 12. In some cases, the memory and/or storage circuitry 926 may also store configuration programs (e.g., bitstream) for programming a programmable fabric of the integrated circuit device 12. The network interface 928 may permit the data processing system 922 to communicate with other electronic devices. The data processing system 922 may include several different packages or may be contained within a single package on a single package substrate.

In one example, the data processing system 922 may be part of a data center that processes a variety of different requests. For instance, the data processing system 922 may receive a data processing request via the network interface 928 to perform machine learning, video processing, voice recognition, image recognition, data compression, database search ranking, bioinformatics, network security pattern identification, spatial navigation, or some other specialized task. The host processor 924 may cause a programmable logic fabric of the integrated circuit device 12 to be programmed with a particular accelerator related to requested task. For instance, the host processor 924 may instruct that configuration data (bitstream) be stored on the memory and/or storage circuitry 926 or cached in sector-aligned memory of the integrated circuit device 12 to be programmed into the programmable logic fabric of the integrated circuit device 12. The configuration data (bitstream) may represent a circuit design for a particular accelerator function relevant to the requested task.

The processes and devices of this disclosure may be incorporated into any suitable circuit. For example, the processes and devices may be incorporated into numerous types of devices such as microprocessors or other integrated circuits. Exemplary integrated circuits include programmable array logic (PAL), programmable logic arrays (PLAs), field programmable logic arrays (FPLAs), electrically programmable logic devices (EPLDs), electrically erasable programmable logic devices (EEPLDs), logic cell arrays (LCAs), field programmable gate arrays (FPGAs), application specific standard products (ASSPs), application specific integrated circuits (ASICs), and microprocessors, just to name a few.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### Example Embodiments of the Disclosure

The following numbered clauses define certain example embodiments of the present disclosure.

Clause 1

An integrated circuit device, comprising:

a programmable fabric comprising a plurality of memory blocks;

a network-on-chip (NOC) located on a shoreline of the programmable fabric; and

at least one micro NOC formed with hardened resources in the programmable fabric, wherein:
the at least one micro NOC is communicatively coupled to the NOC and to at least one memory block of the plurality of memory blocks; and
the at least one micro NOC is configurable to route data between the NOC and the at least one memory block.

Clause 2

The integrated circuit device of clause 1, wherein the plurality of memory blocks is disposed along the at least one micro NOC.

Clause 3

The integrated circuit device of clause 1, comprising a response buffer configurable to receive data transmitted via the NOC and selectively route the data either to the at least one memory block via the at least one micro NOC or to the programmable fabric.

Clause 4

The integrated circuit device of clause 1, wherein the at least one micro NOC comprises a first micro NOC, wherein a first portion of the plurality of memory blocks having a first number of memory blocks and a second portion of the plurality of memory blocks having a second number of memory block are disposed along the first micro NOC.

Clause 5

The integrated circuit device of clause 4, wherein the integrated circuit device is configurable to:

perform a read operation by alternating between reading data from memory blocks of the first portion of the plurality of memory blocks and reading data from memory blocks of the second portion of the plurality of memory blocks;

perform a write operation by alternating between writing data to memory blocks of the first portion of the plurality of memory blocks and writing data to memory blocks of the second portion of the plurality of memory blocks; or both.

Clause 6

The integrated circuit device of clause 4, wherein the integrated circuit device is configurable to:

perform a read operation by simultaneously reading data from a first memory block of the first portion of the plurality of memory blocks and reading data from a second memory block of the second portion of the plurality of memory blocks;

perform a write operation by simultaneously writing data to the first memory block of the first portion of the plurality of memory blocks and reading data from the second memory block of the second portion of the plurality of memory blocks; or both.

Clause 7

The integrated circuit device of clause 4, wherein the first number of memory blocks and the second number of memory blocks are equal.

Clause 8

The integrated circuit device of clause 4, wherein the first number of memory blocks and the second number of memory blocks are different.

Clause 9

The integrated circuit device of clause 4, wherein the first portion of memory blocks comprises a first memory block that is not adjacent to any other memory block of the first portion of memory blocks.

Clause 10

The integrated circuit device of clause 1, wherein the at least one micro NOC is configurable to operate at a different frequency than the plurality of memory blocks.

Clause 11

The integrated circuit device of clause 1, wherein the at least one micro NOC is configurable to route data between the NOC and the at least one memory block without utilizing any programmable resources of the programmable fabric.

Clause 12

A non-transitory, computer-readable medium comprising instructions that, when executed by processing circuitry, cause the processing circuitry to:

receive a user input indicative of an assignment of a plurality of memory blocks disposed along a micro network-on-chip (NOC) of an integrated circuit device, wherein the micro NOC is hardened and communicatively couples the plurality of memory blocks to a NOC of the integrated circuit device, wherein the assignment is indicative of a first portion of the plurality of the memory blocks and a second portion of the plurality of memory blocks that is different than the first portion of the plurality of memory blocks;

generate a bitstream indicative of the assignment; and

send the bitstream to the integrated circuit device to cause the integrated circuit device to become configured to perform one or more read or write operations in which data is transferred, via the micro NOC, between the NOC and at least one of the first portion of the plurality of memory blocks and the second portion of the plurality of memory blocks.

Clause 13

The non-transitory, computer-readable medium of clause 12, wherein:

the first portion of the plurality of memory blocks comprises a first number of memory blocks; and

the second portion of the plurality of memory blocks comprises a second number of memory blocks, wherein the second number of memory blocks is different than the first number of memory blocks.

Clause 14

The non-transitory, computer-readable medium of clause 12, wherein the first portion of the plurality of memory blocks comprises:

a first memory block and a second memory block that are adjacent to one another; and

a third memory block that is not adjacent to any memory block of the first portion of the plurality of memory blocks.

Clause 15

The non-transitory, computer-readable medium of clause 12, wherein the NOC is a hard NOC.

Clause 16

The non-transitory, computer-readable medium of clause 12, wherein the integrated circuit device comprises a field-programmable gate array.

Clause 17

A system comprising:

a substrate;

a first integrated circuit device mounted on the substrate; and

a second integrated device mounted on the substrate, the second integrated circuit device comprising:
a programmable fabric comprising a plurality of memory blocks;
a network-on-chip (NOC) located on a shoreline of the programmable fabric; and
at least one micro NOC formed with hardened resources in the programmable fabric, wherein:
   the at least one micro NOC is communicatively coupled to the NOC and to at least one memory block of the plurality of memory blocks; and
   the at least one micro NOC is configurable to route data between the NOC and the at least one memory block.

Clause 18

The system of clause 17, wherein the second integrated circuit device is configurable to:

perform, using the at least one micro NOC, a first transaction starting at a first memory address of the plurality of memory blocks and ending at a second memory address of the plurality of memory blocks; and

after performing the first transaction, perform a second by beginning to read data from the first memory address or writing data to the first memory address.

Clause 19

The system of clause 17, wherein the second integrated circuit device is configurable to:

perform, using the at least one micro NOC, a first transaction starting at a first memory address of the plurality of memory blocks and ending at a second memory address of the plurality of memory blocks; and

after performing the first transaction, perform a second by beginning to read data from a third memory address or writing data to the third memory address, wherein the third memory address corresponds to a next available memory address not used to perform the first transaction.

Clause 20

The system of clause 17, wherein the first integrated circuit device comprises a processor, and the second integrated device comprises a programmable logic device.

What is claimed is:

1. An integrated circuit device, comprising:
a programmable fabric comprising a plurality of memory blocks;
a network-on-chip (NOC) located on a shoreline of the programmable fabric; and
at least one micro NOC formed with hardened resources in the programmable fabric, wherein:
the at least one micro NOC is communicatively coupled to the NOC and to at least one memory block of the plurality of memory blocks; and
the at least one micro NOC is configurable to route data between the NOC and the at least one memory block.

2. The integrated circuit device of claim 1, wherein the plurality of memory blocks is disposed along the at least one micro NOC.

3. The integrated circuit device of claim 1, comprising a response buffer configurable to receive data transmitted via the NOC and selectively route the data either to the at least one memory block via the at least one micro NOC or to the programmable fabric.

4. The integrated circuit device of claim 1, wherein the at least one micro NOC comprises a first micro NOC, wherein a first portion of the plurality of memory blocks having a first number of memory blocks and a second portion of the plurality of memory blocks having a second number of memory blocks are disposed along the first micro NOC.

5. The integrated circuit device of claim 4, wherein the integrated circuit device is configurable to:
perform a read operation by alternating between reading data from memory blocks of the first portion of the plurality of memory blocks and reading data from memory blocks of the second portion of the plurality of memory blocks;
perform a write operation by alternating between writing data to memory blocks of the first portion of the plurality of memory blocks and writing data to memory blocks of the second portion of the plurality of memory blocks; or
both.

6. The integrated circuit device of claim 4, wherein the integrated circuit device is configurable to:
perform a read operation by simultaneously reading data from a first memory block of the first portion of the plurality of memory blocks and reading data from a second memory block of the second portion of the plurality of memory blocks;
perform a write operation by simultaneously writing data to the first memory block of the first portion of the plurality of memory blocks and reading data from the second memory block of the second portion of the plurality of memory blocks; or
both.

7. The integrated circuit device of claim 4, wherein the first number of memory blocks and the second number of memory blocks are equal.

8. The integrated circuit device of claim 4, wherein the first number of memory blocks and the second number of memory blocks are different.

9. The integrated circuit device of claim 4, wherein the first portion of the plurality of memory blocks comprises a first memory block that is not adjacent to any other memory block of the first portion of memory blocks.

10. The integrated circuit device of claim 1, wherein the at least one micro NOC is configurable to operate at a different frequency than the plurality of memory blocks.

11. The integrated circuit device of claim 1, wherein the at least one micro NOC is configurable to route data between the NOC and the at least one memory block without utilizing any programmable resources of the programmable fabric.

12. A non-transitory, computer-readable medium comprising instructions that, when executed by processing circuitry, cause the processing circuitry to:
receive a user input indicative of an assignment of a plurality of memory blocks disposed along a micro network-on-chip (NOC) of an integrated circuit device, wherein the micro NOC is hardened and communicatively couples the plurality of memory blocks to a NOC of the integrated circuit device, wherein the assignment is indicative of a first portion of the plurality of the memory blocks and a second portion of the plurality of memory blocks that is different than the first portion of the plurality of memory blocks;
generate a bitstream indicative of the assignment; and
send the bitstream to the integrated circuit device to cause the integrated circuit device to become configured to perform one or more read or write operations in which data is transferred, via the micro NOC, between the NOC and at least one of the first portion of the plurality of memory blocks and the second portion of the plurality of memory blocks.

13. The non-transitory, computer-readable medium of claim 12, wherein:
the first portion of the plurality of memory blocks comprises a first number of memory blocks; and
the second portion of the plurality of memory blocks comprises a second number of memory blocks, wherein the second number of memory blocks is different than the first number of memory blocks.

14. The non-transitory, computer-readable medium of claim 12, wherein the first portion of the plurality of memory blocks comprises:
a first memory block and a second memory block that are adjacent to one another; and
a third memory block that is not adjacent to any memory block of the first portion of the plurality of memory blocks.

15. The non-transitory, computer-readable medium of claim 12, wherein the NOC is a hard NOC.

16. The non-transitory, computer-readable medium of claim 12, wherein the integrated circuit device comprises a field-programmable gate array.

17. A system comprising:
a substrate;
a first integrated circuit device mounted on the substrate; and
a second integrated circuit device mounted on the substrate, the second integrated circuit device comprising:
a programmable fabric comprising a plurality of memory blocks;
a network-on-chip (NOC) located on a shoreline of the programmable fabric; and
at least one micro NOC formed with hardened resources in the programmable fabric, wherein:
the at least one micro NOC is communicatively coupled to the NOC and to at least one memory block of the plurality of memory blocks; and
the at least one micro NOC is configurable to route data between the NOC and the at least one memory block.

18. The system of claim 17, wherein the second integrated circuit device is configurable to:
perform, using the at least one micro NOC, a first transaction starting at a first memory address of the plurality of memory blocks and ending at a second memory address of the plurality of memory blocks; and
after performing the first transaction, perform a second by beginning to read data from the first memory address or writing data to the first memory address.

19. The system of claim 17, wherein the second integrated circuit device is configurable to:
perform, using the at least one micro NOC, a first transaction starting at a first memory address of the plurality of memory blocks and ending at a second memory address of the plurality of memory blocks; and
after performing the first transaction, perform a second by beginning to read data from a third memory address or writing data to the third memory address, wherein the third memory address corresponds to a next available memory address not used to perform the first transaction.

20. The system of claim 17, wherein the first integrated circuit device comprises a processor, and the second integrated device comprises a programmable logic device.
